(19) United States
(12) Patent Application Publication
(10) Pub. No.: US 2016/0033686 A1
(43) Pub. Date: Feb. 4, 2016

(54) POLARIZING PLATE PROTECTIVE FILM, POLARIZING PLATE, LIQUID CRYSTAL DISPLAY DEVICE AND MANUFACTURING METHOD OF POLARIZING PLATE PROTECTIVE FILM

(71) Applicant: FUJIFILM CORPORATION, Tokyo (JP)

(72) Inventors: Katsuyuki TAKADA, Kanagawa (JP); Masaaki SUZUKI, Kanagawa (JP); Akio TAMURA, Kanagawa (JP)

(73) Assignee: FUJIFILM CORPORATION, Tokyo (JP)

(21) Appl. No.: 14/813,624

(22) Filed: Jul. 30, 2015

(30) Foreign Application Priority Data
Jul. 31, 2014 (JP) 2014-157038
Jun. 16, 2015 (JP) 2015-120844

(51) Int. Cl. G02B 1/14; B05D 3/06; B05D 1/26; G02B 5/30; G02F 1/1335

(52) U.S. Cl. CPC G02B 1/14; G02B 5/3033; G02F 1/133528; B05D 1/265; B05D 3/067; B05D 3/066

(57) ABSTRACT

There is provided a polarizing plate protective film including a transparent support having a thickness of 40 μm or less, and a hard coat layer having a film thickness of from 3 μm to 15 μm, wherein the hard coat layer is a layer formed by curing a hard coat layer forming composition containing at least the specific compounds, and a polarizing plate comprising: a polarizer, and at least one polarizing plate protective film, as a protective film for the polarizer.

### CROSS-REFERENCE TO RELATED APPLICATIONS

This application claims priority from Japanese Patent Application No. 2014-157038, filed on Jul. 31, 2014, and Japanese Patent Application No. 2015-120844 filed on Jun. 16, 2015, the contents of all of which are hereby incorporated by reference in their entirety.

### BACKGROUND OF THE INVENTION

1. Field of the Invention

The present invention relates to a polarizing plate protective film, a polarizing plate, a liquid crystal display device and a method of manufacturing the polarizing plate protective film.

2. Description of the Related Art

On the surface of an image display device such as a cathode ray tube display (CRT), a plasma display (PDP), an electroluminescence display (ELD), a fluorescent display (VFD), a field emission display (FED) or a liquid crystal display device (LCD), a protective film is provided. A hard coat layer is generally formed in the used protective film to provide a physical strength such as a scratch resistance.

Also, it has been increasingly required to reduce a thickness of an image display device used for, for example, a liquid crystal TV, a mobile phone, a tablet, a small notebook PC in view of a weight reduction and a manufacturing cost reduction, and also to reduce a thickness of a polarizing plate protective film as well.

In order to reduce the thickness of the polarizing plate protective film, it is required to reduce the thickness of a transparent support and a hard coat layer. According to the thickness reduction of the transparent support, the hardness of the polarizing plate protective film may be reduced and the transparent support may not withstand the curing shrinkage of the hard coat layer. Thus, wave-front shaped wrinkles occur in the coating direction of a hard coat layer forming composition, which may reduce the visibility of an image, and deteriorate the flatness of an image display surface. Also, curling may be significantly deteriorated so that a handling property in manufacturing and processing of the polarizing plate protective film may be difficult, cracks may occur in a film during the handling, and a peeling phenomenon may occur after a bonding.

JP-A-2010-107639 discloses a first protective film having a hard coat layer as a protective film of a polarizing film. However, the technology disclosed in Patent Document is not intended to reduce the thickness of the hard coat layer.

Meanwhile, JP-A-2007-237483, JP-A-H08-073771, and JP-A-2003-147017 disclose a polarizing plate protective film with a high surface hardness and a reduced curling, in which the film is obtained by mixing an acrylic compound with an epoxy-based compound.

JP-A-H04-236211 discloses an example in which a compound having an alicyclic epoxy group and a (meth)acrylate group in a molecule is used as an overcoat for an optical disk to suppress a reverse warping.

### SUMMARY OF THE INVENTION

The occurring of curling or wrinkles becomes more significant when the thickness of a transparent support is reduced (e.g., when the thickness is reduced from 80 μm to 40 μm in a triacetyl cellulose film).

With the thinning of the transparent support, the moisture permeability of a polarizing plate protective film is increased. Thus, it was found that when the polarizing plate protective film is used as a polarizing plate protective film, a humidity/heat durability of a polarizing plate may be reduced.

Also, it was found that when a hard coat layer is thinned, a film thickness unevenness of a slight surface may be visually recognized as an interference fringe, and when a film thickness of the hard coat layer is 15 μm or less, a planar shape is significantly deteriorated.

Further, it is required that the polarizing plate protective film is subject to only a small appearance change such as a white turbidity after a humidity/heat test.

In the invention disclosed in JP-A-2007-237483, JP-A-H08-073771, a curling improvement effect is recognized, but there is a problem in that at the time of humidity/heat thermos, an epoxy-based compound may bleed out so that the film is whitened.

When a hard coat layer with a film thickness of 15 μm or less is formed using the curable composition disclosed in JP-A-2003-147017, it was found that there is a room for improvement in terms of an interference fringe and a humidity/heat durability of a polarizing plate (light leakage after a humidity/heat test).

Further, when the curable composition disclosed in JP-A-H04-236211 is used as a polarizing plate protective film, a hardness is insufficient, and also it cannot be said that a curling suppression effect is sufficient.

An object of the present invention is to provide a polarizing plate protective film in which the occurrence of curling is suppressed and a flatness and a humidity/heat durability are excellent without damage to a surface hardness of the film, and a manufacturing method thereof. Another object of the present invention is to provide a polarizing plate and a liquid crystal display device which include the polarizing plate protective film, and are excellent in the humidity/heat durability.

The problems to be solved by the present invention may be solved by the present invention which is a following means.

[1] A polarizing plate protective film comprising:

a transparent support having a thickness of 40 μm or less, and

a hard coat layer having a film thickness of from 3 μm to 15 μm,

wherein the hard coat layer is a layer formed by curing a hard coat layer forming composition containing at least the following compounds (a) and (b), and

the hard coat layer forming composition contains the compound (a) in an amount of 5% to 40% by mass and the compound (b) in an amount of 40% by mass to 95% by mass, based on 100% by mass of the total solid content of the hard coat layer forming composition:

(a) a compound having a repeating unit represented by the following Formula (1) and having a weight average molecular weight of 1500 or more,

(b) a compound having three or more ethylenically unsaturated double bonding groups in a molecule:

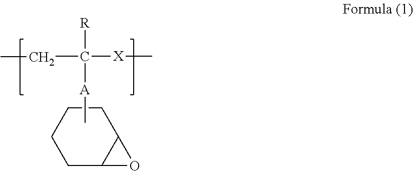

in Formula (1),

R represents a hydrogen atom or a methyl group,

X represents a single bond, or an oxygen atom, an alkylene group which may have a substituent, an arylene group which may have a substituent, an aralkylene group which may have a substituent, an ester bond, a carbonyl bond, —NH— or a linking group formed by combining them,

A represents a single bond, or an alkylene group which may have a substituent, an arylene group which may have a substituent, an aralkylene group which may have a substituent, an ester bond, an ether bond, a carbonyl bond, —NH— or a linking group formed by combining them.

[2] The polarizing plate protective film as described in [1],

wherein the hard coat layer forming composition contains (c) inorganic fine particles reactive with an epoxy group or an ethylenically unsaturated double bonding group in an amount of 5% to 40% by mass based on 100% by mass of the total solid content of the hard coat layer forming composition.

[3] The polarizing plate protective film as described in [1] or [2],

wherein the hard coat layer forming composition contains (d) a nonionic fluorine-containing surfactant represented by the following Formula (2):

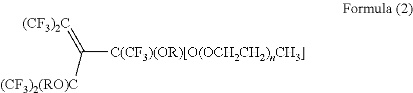

in Formula (2),

R represents an alkyl group having 1 to 6 carbon atoms, and

n represents a number of 3 to 50.

[4] The polarizing plate protective film as described in any one of [1] to [3],

wherein a thickness of the transparent support is 30 μm or less.

[5] The polarizing plate protective film as described in any one of [1] to [4],

wherein the transparent support is a cellulose acylate film, and a thickness of the transparent support is 25 μm or less.

[6] The polarizing plate protective film as described in any one of [1] to [5],

wherein a thickness of the hard coat layer is from 3 μm to 10 μm.

[7] The polarizing plate protective film as described in any one of [1] to [6], containing the compound (a) in an amount of 5% by mass to 22% by mass.
[8] A polarizing plate comprising:

a polarizer, and

at least one polarizing plate protective film described in any one of [1] to [7], as a protective film for the polarizer.

[9] A liquid crystal display device comprising:

a liquid crystal cell, and

the polarizing plate described in claim 8, which is disposed at least one side surface of the liquid crystal cell,

wherein the polarizing plate protective film is disposed at an outermost surface.

[10] A method of manufacturing a polarizing plate protective film which contains a transparent support with a thickness of 40 μm or less and a hard coat layer with a film thickness ranging from 3 μm to 15 μm,

wherein the hard coat layer is a layer formed by curing a hard coat layer forming composition containing at least the following compounds (a) and (b), and

the hard coat layer forming composition contains the compound (a) in an amount of 5% to 40% by mass and the compound (b) in an amount of 40% by mass to 95% by mass based on 100% by mass of the total solid content of the hard coat layer forming composition:

(a) a compound having a repeating unit represented by Formula (1) below and having a weight average molecular weight of 1500 or more,

(b) a compound having three or more ethylenically unsaturated double bonding groups in a molecule:

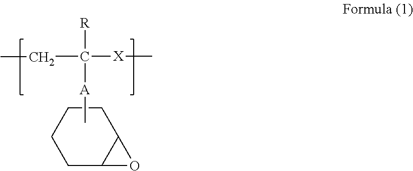

in Formula (1),

R represents a hydrogen atom or a methyl group,

X represents a single bond, or an oxygen atom, an alkylene group which may have a substituent, an arylene group which may have a substituent, an aralkylene group which may have a substituent, an ester bond, a carbonyl bond, —NH— or a linking group formed by combining them,

A represents a single bond, or an alkylene group which may have a substituent, an arylene group which may have a substituent, an aralkylene group which may have a substituent, an ester bond, an ether bond, a carbonyl bond, —NH— or a linking group formed by combining them.

According to the present invention, there may be provided a polarizing plate protective film in which the occurrence of curling is suppressed and a flatness and a humidity/heat durability are excellent without damage to a surface hardness of the film, and a manufacturing method thereof. Also, according to the present invention, there may be provided a polarizing plate and a liquid crystal display device which include the polarizing plate protective film, and are excellent in the humidity/heat durability.

### DETAILED DESCRIPTION OF THE INVENTION

The descriptions of the constituent features described below may be made based on representative exemplary embodiments of the present invention, but the present invention is not limited to the exemplary embodiments. Also, in the present specification, a numerical range expressed by using “to” means a range including numerical values described before and after “to” as a lower limit and an upper limit. An “acrylic resin” refers to a resin obtained by polymerizing a derivative of methacrylic acid or acrylic acid, or a resin containing the derivative. Also, unless otherwise limited, “(meth)acrylate” refers to acrylate or methacrylate, and “(meth)acrylic” refers to acrylic or methacrylic.

### <Polarizing Plate Protective Film>

A polarizing plate protective film of the present invention is a polarizing plate protective film which contains a transparent support with a thickness of 40 μm or less and a hard coat layer with a film thickness ranging from 3 μm to 15 μm,

in which the hard coat layer is a layer formed by curing a hard coat layer forming composition containing at least compounds of (a) and (b) below, and

the hard coat layer forming composition contains the compound (a) in an amount of 5% to 40% by mass and the compound (b) in an amount of 40% by mass to 95% by mass based on 100% by mass of the total solid content of the hard coat layer forming composition.

The compound (a) is a compound having a repeating unit represented by Formula (1) below and having a weight average molecular weight of 1500 or more.

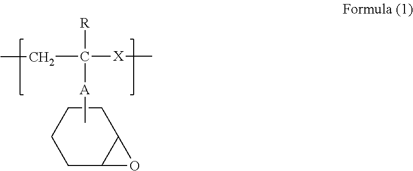

In Formula (1), R represents a hydrogen atom or a methyl group,

X represents a single bond, or an oxygen atom, an alkylene group which may have a substituent, an arylene group which may have a substituent, an aralkylene group which may have a substituent, an ester bond, a carbonyl bond, —NH— or a linking group composed of a combination of these, and

A represents a single bond, or an alkylene group which may have a substituent, an arylene group which may have a substituent, an aralkylene group which may have a substituent, an ester bond, an ether bond, a carbonyl bond, —NH— or a linking group composed of a combination of these.

The compound (b) is a compound having three or more ethylenically unsaturated double bonding groups in the molecule.

### [Compound (a) Having Repeating Unit Represented by Formula (1) and Weight Average Molecular Weight of 1500 or More]

In the present invention, a hard coat layer forming composition contains a compound (a) which has a repeating unit represented by Formula (1) and a weight average molecular weight of 1500 or more.

In Formula (1), X represents a single bond, or an oxygen atom, an alkylene group which may have a substituent, an arylene group which may have a substituent, an aralkylene group which may have a substituent, an ester bond, a carbonyl bond, —NH— or a linking group composed of a combination of these.

When X represents an alkylene group, the alkylene group may be linear, branched or cyclic. As for the alkylene group, an alkylene group having 1 to 6 carbon atoms is preferred, and an alkylene group having 1 to 3 carbon atoms is more preferred. As for the alkylene group, specifically, a methylene group, an ethylene group, a propylene group, and a cyclohexylene group are preferred.

When X represents an arylene group, an arylene group having 6 to 18 carbon atoms is preferred, and an arylene group having 6 to 12 carbon atoms is more preferred. As for the arylene group, specifically, a phenylene group, and a naphthylene group are preferred.

When X represents an aralkylene group, an aralkylene group having 7 to 19 carbon atoms is preferred, and an aralkylene group having 7 to 13 carbon atoms is more preferred. As for the aralkylene group, an aralkylene group having the alkylene group in a preferred range and the arylene group in a preferred range is preferred.

Also, X may be a linking group formed by a combination with the above described linking group, and examples of the linking group formed by a combination may include a linking group formed by a combination of an ester bond and an alkylene group, a linking group formed by a combination of an arylene group, an ester bond, and an alkylene group, a linking group formed by a combination of an alkylene group and an ether bond, a linking group formed by a combination of a carbonyl bond, —NH—, an alkylene group, and an ether bond.

As for X, a single bond is most preferred.

In Formula (1), A represents a single bond, or an alkylene group which may have a substituent, an arylene group which may have a substituent, an aralkylene group which may have a substituent, an ester bond, an ether bond, a carbonyl bond, —NH— or a linking group composed of a combination of these.

When A represents an alkylene group, the alkylene group may be linear, branched or cyclic. As for the alkylene group, an alkylene group having 1 to 6 carbon atoms is preferred, an alkylene group having 1 to 3 carbon atoms is more preferred. As for the alkylene group, specifically, a methylene group, an ethylene group, a propylene group, and a cyclohexylene group are preferred.

When A represents an arylene group, an arylene group having 6 to 18 carbon atoms is preferred, and an arylene group having 6 to 12 carbon atoms is more preferred. As for the arylene group, specifically, a phenylene group, and a naphthylene group are preferred.

When A represents an aralkylene group, an aralkylene group having 7 to 19 carbon atoms is preferred, and an aralkylene group having 7 to 13 carbon atoms is more preferred. As for the aralkylene group, an aralkylene group having the alkylene group in a preferred range and the arylene group in a preferred range is preferred.

Also, A may be a linking group formed by a combination with the above described linking group, and examples of the linking group formed by a combination may include a linking group formed by a combination of an ester bond and an alkylene group, a linking group formed by a combination of an arylene group, an ester bond and an alkylene group, a linking group formed by a combination of an alkylene group and an ether bond, and a linking group formed by a combination of a carbonyl bond, —NH—, an alkylene group and an ether bond.

As for A, an ester bond, an ether bond, —CONH—, an alkylene group, an arylene group or a linking group composed of a combination of these is preferred.

Specific examples of the repeating unit represented by Formula (1) are described below, but are not limited thereto.

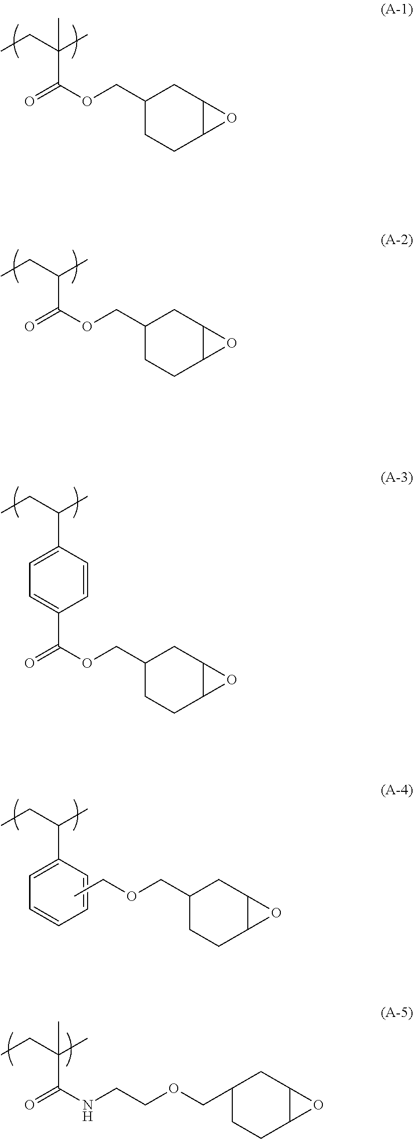

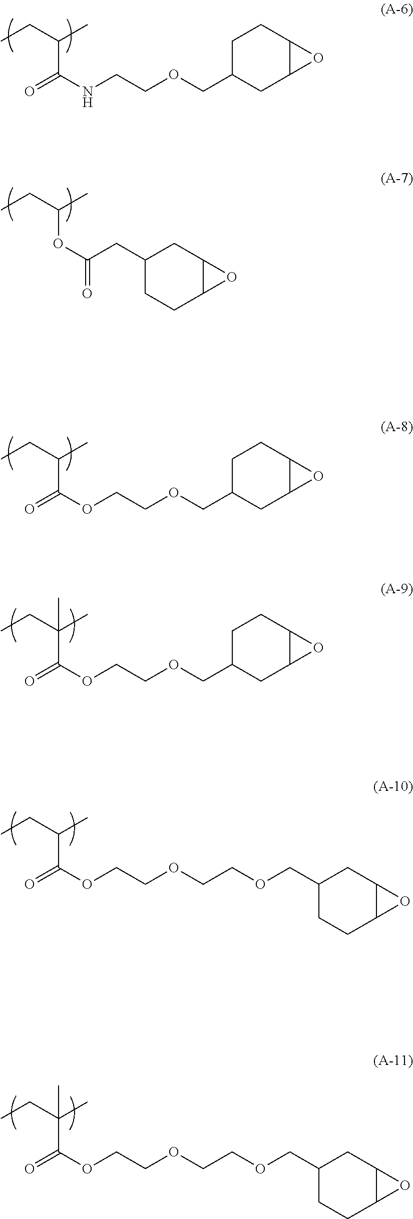

The weight average molecular weight (MW) of the compound (a) is 1500 or more, and is preferably 3000 or more, more preferably 10000 or more, and further preferably 50000 or more. The weight average molecular weight of the compound (a) is preferably 1,000,000 or less, more preferably 500,000 or less, and further preferably 250,000 or less.

When the weight average molecular weight of the compound (a) is 1500 or more, a polarizing plate protective film excellent in flatness may be obtained, and a polarizing plate excellent in humidity/heat durability may be obtained.

The weight average molecular weight of the compound (a) is defined as a value in terms of polystyrene through gel permeation chromatography(GPC) measurement (solvent: tetrahydrofuran, column. TSKgel Super HZM-H, TSKgel SuperHZ4000, TSKgel SuperHZ200 manufactured by TOSOH CORPORATION, column temperature: 40° C., flow rate: 1.0 mL/min, detector: RI).

The compound (a) may have only one kind of repeating unit represented by Formula (1) or two or more kinds of repeating units. The compound (a) may have a repeating unit other than the repeating unit represented by Formula (1) as long as an effect of the present invention is not impaired. The introduction of the repeating unit other than that of Formula (1) may be performed by copolymerizing a corresponding monomer.

When a corresponding vinyl monomer is copolymerized in the introduction of the repeating unit other than that of Formula (1), examples of the preferable monomer may include esters or amides derived from acrylic acids or α-alkyl acrylic acids (e.g., methacrylic acids) (such as, N-i-propylacrylamide, N-n-butylacrylamide, N-t-butylacrylamide, N,N-dimethylacrylamide, N-methylmethacrylamide, acrylamide, 2-acrylamide-2-methylpropane sulfonic acid, acrylamidepropyltrimethylammonium chloride, methacrylamide, diacetoneacrylamide, acryloyl morpholine, N-methylolacrylamide, N-methylolmethacrylamide, methylacrylate, ethylacrylate, hydroxyethylacrylate, n-propylacrylate, i-propylacrylate, 2-hydroxypropylacrylate, 2-methyl-2-nitropropylacrylate, n-butylacrylate, i-butylacrylate, t-butylacrylate, t-pentylacrylate, 2-methoxyethylacrylate, 2-ethoxyethylacrylate, 2-methoxymethoxyethylacrylate, 2,2,2-trifluoroethylacrylate, 2,2-dimethylbutylacrylate, 3-methoxybutylacrylate, ethylcarbitolacrylate, phenoxyethylacrylate, n-pentylacrylate, 3-pentylacrylate, octafluoropentylacrylate, n-hexylacrylate, cyclohexylacrylate, cyclopentylacrylate, cetyl acrylate, benzylacrylate, n-octylacrylate, 2-ethylhexylacrylate, 4-methyl-2-propylpentylacrylate, heptadecafluorodecylacrylate, n-octadecyl acrylate, methylmethacrylate, 2,2,2-trifluoroethylmethacrylate, tetrafluoropropylmethacrylate, hexafluoropropylmethacrylate, hydroxyethylmethacrylate, 2-hydroxypropylmethacrylate, n-butylmethacrylate, i-butylmethacrylate, sec-butylmethacrylate, n-octylmethacrylate, 2-ethylhexylmethacrylate, 2-methoxyethylmethacrylate, 2-ethoxyethylmethacrylate, benzylmethacrylate, heptadecafluorodecylmethacrylate, n-octadecylmethacrylate, 2-isobornylmethacrylate, 2-norbonylmethylmethacrylate, 5-norbornene-2-ylmethylmethacrylate, 3-methyl-2-norbonylmethylmethacrylate, dimethylaminoethylmethacrylate), acrylic acids or α-alkylacrylic acids (such as acrylic acid, methacrylic acid, itaconic acid), vinyl esters (such as vinyl acetate), esters derived from maleic acids or fumaric acids (such as dimethyl maleate, dibutyl maleate, diethyl fumarate), maleimides (such as N-phenylmaleimide), maleic acid, fumaric acid, sodium salt of p-styrenesulfonic acid, acrylonitrile, methacrylonitrile, dienes (such as butadiene, cyclopentadiene, isoprene), aromatic vinyl compounds (such as styrene, p-chlorostyrene, t-butylstyrene, α-methylstyrene, sodium styrenesulfonate), N-vinylpyrrolidone, N-vinyloxazolidone, N-vinylsuccinimide, N-vinylformamide, N-vinyl-N-methylformamide, N-vinylacetamide, N-vinyl-N-methylacetamide, 1-vinylimidazole, 4-vinylpyridine, vinylsulfonic acid, sodium vinyl sulfonate, sodium allyl sulfonate, sodium methallyl sulfonate, vinylidene chloride, vinylalkylethers (such as methylvinylether), ethylene, propylene, and 1-butene, isobutene. These vinyl monomers may be used in combination of two or more kinds thereof. As for a vinyl monomer other than these, those described in Research Disclosure No. 1955 (July, 1980) may be used. In the present invention, esters and amides derived from acrylic acids or methacrylic acids, and aromatic vinyl compounds may be particularly preferably used as vinyl monomers.

As for the repeating unit other than that of Formula (1), a repeating unit having a reactive group other than an epoxy group may be introduced. Particularly, in order to increase the hardness of the hard coat layer, or in order to improve the adhesion between layers in a case where an additional functional layer is used in a substrate or a hard coat, a method of using a compound containing a reactive group other than an epoxy group is preferred. As for a method of introducing a repeating unit having a reactive group other than an epoxy group, a method of copolymerizing a corresponding vinyl monomer (hereinafter, referred to as a “reactive monomer”) is simple and preferred.

Preferred specific examples of the reactive monomer are described below, but the present invention is not limited thereto.

Hydroxyl group-containing vinyl monomers (e.g., hydroxyethylacrylate, hydroxyethylmethacrylate, allyl alcohol, hydroxypropylacrylate, hydroxypropylmethacrylate), isocyanate group-containing vinyl monomers (e.g., isocyanato ethylacrylate, isocyanato ethylmethacrylate), N-methylol group-containing vinyl monomers (e.g., N-methylolacrylamide, N-methylolmethacrylamide), carboxyl group-containing vinyl monomers (e.g., acrylic acid, methacrylic acid, itaconic acid, carboxyethylacrylate, vinyl benzoate), alkylhalide-containing vinyl monomers (e.g., chloro methylstyrene, 2-hydroxy-3-chloropropylmethacrylate), acid anhydride-containing vinyl monomers (e.g., maleic anhydride), formyl group-containing vinyl monomers (e.g., acrolein, methacrolein), sulfinic acid-group containing vinyl monomers (e.g., potassium styrenesulfinic acid), active methylene-containing vinyl monomers (e.g., acetoacetoxy ethylmethacrylate), acidchloride-containing monomers (e.g., acrylic acidchloride, methacrylic acid chloride), amino-group containing monomers (e.g., allyl amine), alkoxysilyl group-containing monomers (e.g., methacryloyloxy propyl trimethoxysilane, acryloyl oxypropyl trimethoxysilane) may be exemplified.

In a case where the repeating unit other than that of Formula (1) does not have a crosslinking reactive group, when the content thereof is too large, the hardness decreases, and in a case where the repeating unit has a reactive group, the hardness may be maintained but a curing shrinkage may become large and a brittleness may be deteriorated. Particularly, when a crosslinking reaction is accompanied by a molecular weight reduction such as dehydration or dealcoholization as in a case where a copolymer of an alkoxysilyl group-containing monomer (e.g., example methacryloyloxy propyltrimethoxysilane) and a repeating unit represented by Formula (1) is used, a curing shrinkage may be increased. When such a repeating unit having a crosslinking reactive group which proceeds a crosslinking reaction accompanied by a molecular weight reduction is introduced into a compound containing a repeating unit represented by Formula (1) of the present invention, the repeating unit represented by Formula (1) is preferably included in a ratio of 70% to 99% by mass, more preferably of 80% to 99% by mass, and particularly preferably of 90% to 99% by mass. (In this specification, mass ratio is equivalent to weight ratio.)

The compound (a) is included in an amount of 5% to 40% by mass based on 100% by mass of the total solid content of the hard coat layer forming composition in the present invention. When the content of the compound (a) is 5% by mass or more and 40% by mass or less, a polarizing plate protective film with a reduced curling may be obtained.

The compound (a) is included preferably in an amount of 5% to 40% by mass based on 100% by mass of the total solid content of the hard coat layer forming composition in the present invention, more preferably of 5% to 22% by mass, and further more preferably of 10% to 22% by mass.

The compound (a) may be synthesized by a conventionally method disclosed in Japanese Patent Application Laid-Open No. 2003-147017.

### [Compound (b) Having Three or More Ethylenically Unsaturated Double Bonding Groups in Molecule]

Hereinafter, a compound (b) having three or more ethylenically unsaturated double bonding groups in the molecule, which is included in the hard coat layer forming composition in the present invention, will be described. The compound having three or more ethylenically unsaturated double bonding groups in the molecule is also referred to as a “compound (b).”

The compound (b) has three or more ethylenically unsaturated double bonding groups in the molecule to achieve a high hardness.

The number of ethylenically unsaturated double bonding groups included in the molecule is preferably 4 or more, and more preferably 6 or more. The upper limit of the number of ethylenically unsaturated double bonding groups included in the molecule is preferably 20 or less.

As for the compound (b), an ester of polyhydric alcohol and (meth)acrylic acid, vinyl benzene and its derivative, vinyl sulfone, and (meth)acrylamide may be exemplified. Among them, in terms of hardness, a compound having three or more (meth)acryloyl groups is preferred, and an acrylate-based compound which is widely used in the art and forms a cured product with a high hardness may be exemplified. As for the compound, esters of polyhydric alcohol and (meth)acrylic acid such as pentaerythritol tetra (meth) acrylate, pentaerythritol tri (meth) acrylate, trimethylolpropane tri (meth) acrylate, EO modified tri trimethylolpropane tri (meth) acrylate, PO-modified trimethylolpropane tri (meth) acrylate, EO-modified phosphoric acid tri (meth) acrylate, trimethylolethane tri (meth) acrylate, ditrimethylolpropane tetra (meth) acrylate, dipentaerythritol tetra (meth) acrylate, dipentaerythritol penta (meth) acrylate, dipentaerythritol hexa (meth) acrylate, pentaerythritol hexa (meth) acrylate, 1,2,3-cyclohexane tetramethacrylate, polyurethane polyacrylate, polyester polyacrylate, and caprolactone-modified tris (acryloxyethyl) isocyanurate may be exemplified.

Specific examples of the multifunctional acrylate-based compounds having three or more (meth)acryloyl groups may include esters of polyol and (meth)acrylic acid such as KAYARAD DPHA, DPHA-2C, PET-30, TMPTA, TPA-320, TPA-330, RP-1040, T-1420, D-310, DPCA-20, DPCA-30, DPCA-60, GPO-303 (manufactured by Nippon Kayaku Co., Ltd.), and V#400, V#36095D (manufactured by OSAKA ORGANIC CHEMICAL INDUSTRY LTD.). Also, urethane acrylate compounds having three or more functional groups such as purple light UV-1400B, UV-1700B, UV-6300B, UV-7550B, UV-7600B, UV-7605 B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, UV-2750B (manufactured by The Nippon Synthetic Chemical Industry Co., Ltd.), UL-503LN (manufactured by KYOEISHA CHEMICAL Co., Ltd.), UNIDIC 17-806, 17-813, V-4030, V-4000BA (manufactured by DIC Corporation), EB-1290K, EB-220, EB-5129, EB-1830, EB-4358 (manufactured by DAICEL-UCB Co., Ltd.), HI-COAP AU-2010, AU-2020 (manufactured by TOKUSHIKI Co., Ltd.), ARONIX M-1960 (manufactured by TOAGOSEI CO., LTD.), ARTRESIN UN-3320HA, UN-3320HC, UN-3320HS, UN-904, HDP-4T, and polyester compounds having three or more functional groups such as ARONIX M-8100, M-8030, M-9050 (manufactured by TOAGOSEI CO., LTD., KBM-8307 (manufactured by DAICEL-CYTEC Company Ltd.) may be properly used.

The compound (b) may be a single compound or a plurality of compounds may be used in combination.

The compound (b) is included in an amount of 40% to 95% by mass based on 100% by mass of the total solid content of the hard coat layer forming composition in the present invention. When the content of the compound (b) is 40% by mass or more, a polarizing plate protective film excellent in flatness and interference fringe may be obtained, and a polarizing plate excellent in a humidity/heat durability may be obtained. When the content of the compound (b) is 95% by mass or less, a polarizing plate protective film excellent in curling and flatness may be obtained, and a polarizing plate excellent in a humidity/heat durability may be obtained.

The compound (b) is included preferably in an amount of 40% to 95% by mass based on 100% by mass of the total solid content of the hard coat layer forming composition in the present invention, more preferably of 50% to 85% by mass, and further more preferably of 60% to 80% by mass.

[(c) Inorganic Fine Particles Reactive with Epoxy Group or Ethylenically Unsaturated Double Bonding Group]

In the hard coat layer forming composition in the present invention, inorganic fine particles (c) reactive with an epoxy group or an ethylenically unsaturated double bonding group are preferably added. The inorganic fine particles (c) reactive with an epoxy group or an ethylenically unsaturated double bonding group are also referred to as “inorganic fine particles (c).” By adding the inorganic fine particles (c), the curing shrinkage amount of a cured layer may be reduced, thereby further reducing the curling of a film. Further, by using the inorganic fine particles (c) reactive with an epoxy group or an ethylenically unsaturated double bonding group, a pencil hardness may be improved. As for the inorganic fine particles, silica particles, titanium dioxide particles, zirconium oxide particles, and aluminum oxide particles may be exemplified. Among them, silica particles are preferred.

In general, the inorganic fine particles have a low affinity with an organic component such as a polyfunctional vinyl monomer, and thus a cured layer may be easily cracked when aggregates are formed through simple mixing. Therefore, in the inorganic fine particles (c) of the present invention, in order to increase the affinity between the inorganic fine particles and the organic component, and to impart reactivity with an epoxy group or an ethylenically unsaturated double bonding group, the surfaces of the inorganic fine particles are treated with a surface modifying agent containing an organic segment.

Preferably, the surface modifying agent has a functional group capable of forming a bond with inorganic fine particles or adsorbing to the inorganic fine particles, and a functional group having a high affinity to an organic component in the same molecule. As for a surface modifying agent which has a functional group capable of bonding or adsorbing to the inorganic fine particles, a metal alkoxide surface modifying agent such as silane, aluminum, titanium, zirconium, or a surface modifying agent having an anionic group such as a phosphoric acid, a sulfuric acid group, a sulfonic acid group, or a carboxylic acid group is preferred.

As for the functional group having a high affinity with an organic component, an organic component may be simply added with hydrophilicity/hydrophobicity, but a functional group capable of being chemically bonded to an organic component is preferred, and an ethylenically unsaturated double bonding group, or a ring-opening polymerizable group is particularly preferred.

In the present invention, a preferred surface modifying agent for inorganic fine particles is a curable resin which has a metal alkoxide or an anionic group and an ethylenically unsaturated double bonding group or a ring-opening polymerizable group in the same molecule. Through chemical bonding to an organic component, a cross-linking density of a hard coat layer is increased, thereby increasing a pencil hardness.

Representative examples of the surface modifying agent may include an unsaturated double bond-containing coupling agent, a phosphate group-containing organic curable resin, a sulfate group-containing organic curable resin, a carboxylic acid group-containing organic curable resin as described below.

H₂C═C(X)COOC₃H₆Si(OCH₃)₃ S-1

H₂C═C(X)COOC₂H₄OTi(OC₂H₅)₃ S-2

H₂C═C(X)COOC₂H₄OCOC₅H₁₀OPO(OH)₂ S-3

(H₂C═C(X)COOC₂H₄OCOC₅H₁₀O)₂POOH S-4

H₂C═C(X)COOC₂H₄OSO₃H S-5

H₂C═C(X)COO(C₅H₁₀COO)₂H S-6

H₂C═C(X)COOC₅H₁₀COOH S-7

CH₂CH(O)CH₂OC₃H₆Si(OCH₃)₃ S-8
(X represents a hydrogen atom or CH₃)

Representative examples of the ring-opening polymerizable group may include KBM-303, KBM-402, KBM403, KBE-402, KBE-403 manufactured by Shin-Etsu Chemical Co., Ltd.

The surface modification of the inorganic fine particles is preferably made in a solution. When the inorganic fine particles are mechanically finely dispersed, a surface modifying agent may be present together. After the inorganic fine particles are finely dispersed, a surface modifying agent may be added, followed by stirring. Otherwise, surface modification may be carried out before fine dispersion of the inorganic fine particles (as necessary, after warming and drying, heating or pH change may be made), and then fine dispersion may be performed. As for the solution for dissolving the surface modifying agent, an organic solvent with a large polarity is preferred. Specifically, conventionally known solvents such as alcohol, ketone, ester may be exemplified.

The addition amount of the inorganic fine particles (c) preferably ranges from 5% to 40% by mass, and more preferably from 10% to 30% by mass based on 100% by mass of the total solid content of the hard coat layer forming composition of the present invention, in view of balance of hardness, brittleness, curling and flatness of a coating film. The size (average primary particle diameter) of the inorganic fine particles preferably ranges from 10 nm to 100 nm, and more preferably from 10 nm to 60 nm. The average particle diameter of fine particles may be obtained from an electron micrograph.

The shape of the inorganic fine particles may be spherical or non-spherical, but a non-spherical form in which 2 to 10 inorganic fine particles are linked is preferred in view of hardness and curling. It is assumed that when several inorganic fine particles linked in a chain form are used, a strong particle network structure is formed, thereby improving a hardness.

Specific examples of the inorganic fine particles may include ELECOM V-8802 (spherical silica fine particles with an average particle diameter of 12 nm, manufactured by JGC CORPORATION), ELECOM V-8803 (silica fine particles in an irregular form, manufactured by JGC CORPORATION), MiBK-SD (spherical silica fine particles with an average particle diameter of 10 nm to 20 nm, manufactured by NISSAN CHEMICAL INDUSTRIES LTD.), MEK-AC-2140Z (spherical silica fine particles with an average particle diameter of 10 nm to 20 nm, manufactured by NISSAN CHEMICAL INDUSTRIES LTD.), MEK-AC-4130 (spherical silica fine particles with an average particle diameter of 40 nm to 50 nm, manufactured by NISSAN CHEMICAL INDUSTRIES LTD.), MiBK-SD-L (spherical silica fine particles with an average particle diameter of 40 nm to 50 nm, manufactured by NISSAN CHEMICAL INDUSTRIES LTD.), MEK-AC-5140Z (spherical silica fine particles with an average particle diameter of 70 nm to 100 nm, manufactured by NISSAN CHEMICAL INDUSTRIES LTD.). Among them, ELECOM V-8803 in an irregular form is preferred in view of curling and hardness.

### [Surfactant]

In the hard coat layer forming composition of the present invention, various surfactants may be properly used. in general, the surfactant may suppress a film thickness unevenness caused by uneven drying due to a local distribution of a drying air.

As for the surfactant, (d) a nonionic fluorine-containing surfactant represented by Formula (2) below is particularly preferred.

That is, preferably, the hard coat layer forming composition of the present invention includes a nonionic fluorine-containing surfactant (d) (which may be referred to as “a surfactant (d)”) represented by Formula (2) below.

The inclusion of the surfactant (d) may more effectively suppress an interference fringe and thus is preferable.

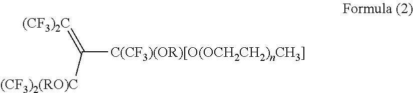

In Formula (2), R represents an alkyl group having 1 to 6 carbon atoms, and n represents a number of 3 to 50.

In Formula (2) above, R preferably represents an alkyl group having 1 to 2 carbon atoms, and n preferably represents a number of 8 to 22.

The surfactant (d) may be used alone or in combination of two or more kinds thereof. The surfactant (d) may be preferably added in a range of 0.001% to 5.0% by mass, and more preferably added in a ratio of 0.02% to 1.0% by mass based on 100% by mass of the total solid content of the hard coat layer forming composition of the present invention.

The compound represented by Formula (2) may be synthesized by a conventionally known method disclosed in Japanese Patent Application Laid-Open No. 2006-342087.

As for the surfactant, a surfactant other than the surfactant (d) may also be used, and specifically, either a fluorine-based surfactant or a silicon-based surfactant or both of them may be contained. The surfactant is preferably an oligomer or a polymer rather than a low-molecular compound.

As for preferred examples of the fluorine-based surfactant, a fluoroaliphatic group-containing copolymer (hereinafter, may be abbreviated as “fluorine-based polymer”) may be exemplified. As for the fluorine-based polymer, an acrylic resin, a methacrylic resin and a copolymer of a vinyl-based monomer copolymerizable with them, which includes a repeating unit corresponding to a monomer (i) below, or a repeating unit corresponding to a monomer (i) and a repeating unit corresponding to a monomer (ii) below is useful.

(i) a fluoroaliphatic group-containing monomer represented by Formula (A):

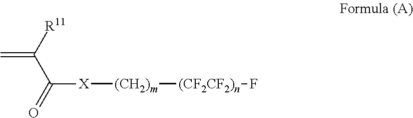

In Formula (A), R¹¹ represents a hydrogen atom or a methyl group, X represents an oxygen atom, a sulfur atom or —N(R12)-, m represents an integer of 1 to 6, and n represents an integer of 2 to 4. R12 represents a hydrogen atom or an alkyl group having 1 to 4 carbon atoms, and specifically represents a methyl group, an ethyl group, a propyl group, or a butyl group, and preferably a hydrogen atom or a methyl group. As for X, an oxygen atom is preferred.

(ii) a monomer represented by Formula (B) below which is copolymerizable with monomer (i):

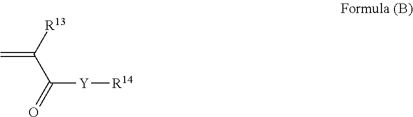

In Formula (B), R¹³ represents a hydrogen atom or a methyl group, Y represents an oxygen atom, a sulfur atom or —N(R15)-, R15 represents a hydrogen atom or an alkyl group having 1 to 4 carbon atoms, and specifically represents a methyl group, an ethyl group, a propyl group, or a butyl group, and preferably a hydrogen atom or a methyl group. As for Y, an oxygen atom, —N(H)— or —N(CH3)- is preferred.

R¹⁴ represents a linear, branched or cyclic alkyl group having 4 to 20 carbon atoms, which may have a substituent. As for the substituent of the alkyl group of R¹⁴, a hydroxyl group, an alkylcarbonyl group, an aryl carbonyl group, a carboxyl group, an alkylether group, an arylether group, a halogen atom such as a fluorine atom, a chlorine atom, or a bromine atom, a nitro group, a cyano group, and an amino group may be exemplified, but not limited thereto. As for the linear, branched or cyclic alkyl group having 4 to 20 carbon atoms, a linear or branched butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, and an eicosanyl group, a monocyclic cycloalkyl group such as a cyclohexyl group and a cycloheptyl group, and a polycyclic cycloalkyl group such as a bicycloheptyl group, a bicyclodecyl group, a tricycloundecyl group, a tetracyclododecyl group, an adamantyl group, a norbonyl group, and a tetracyclodecyl group are preferably used.

The amount of the fluoroaliphatic group-containing monomer represented by Formula (A) which is used for the fluorine-based polymer is 10 mol % or more, based on each monomer of the fluorine-based polymer, and preferably ranges from 15 mol % to 70 mol %, and more preferably from 20 mol % to 60 mol %.

A preferred weight average molecular weight of the fluorine-based polymer preferably ranges from 3000 to 100,000, and more preferably from 5,000 to 80,000. A preferred addition amount of the fluorine-based polymer ranges from 0.001 parts to 5 parts by mass, based on 100 parts by mass of the hard coat layer forming composition, and more preferably ranges from 0.005 parts to 3 parts by mass, and further preferably from 0.01 parts to 1 parts by mass. When the addition amount of the fluorine-based polymer is 0.001 parts by mass or more, the addition effect of the fluorine-based polymer is sufficiently obtained, and when the amount is 5 parts by mass or less, problems causing an insufficient drying of a coating film or causing an adverse effect on a performance as the coating film do not occur.

Preferred examples of the silicon-based compound may include “X-22-174DX”, “X-22-2426”, “X22-164C”, “X-22-176D” (these are product names) manufactured by Shin-Etsu Chemical Co., Ltd.; “FM-7725”, “FM-5521”, “FM-6621” (these are product names) manufactured by CHISSO CORPORATION; “DMS-U22”, “RMS-033” (these are product names) manufactured by Gelest; “SH200”, “DC11PA”, “ST80PA”, “L7604”, “FZ-2105”, “L-7604”, “Y-7006”, “SS-2801” (these are product names) manufactured by Dow Corning Toray Co., Ltd.; and “TSF400” (product name) manufactured by MOMENTIVE PERFORMANCE MATERIALS JAPAN, but are not limited thereto.

The silicon-based surfactant is preferably contained in a range of 0.01% to 0.5% by mass and more preferably of 0.01% to 0.3% by mass, based on 100% by mass of the total solid content of the hard coat layer forming composition of the present invention.

### [Radical Polymerization Initiator]

The hard coat layer forming composition in the present invention may also contain a radical polymerization initiator.

Polymerization of a compound having an ethylenically unsaturated group may be performed by irradiation with ionizing radiation or heating in the presence of a photoradical polymerization initiator or a thermal radical polymerization initiator. As for the photoradical and thermal radical polymerization initiators, commercially available compounds may be used, and these are described in “Latest UV curing technology” (p. 159, issuer; KAZUHIRO TAKAUSU, publisher; TECHNICAL INFORMATION INSTITUTE CO., LTD., issued in 1991), or the catalog of Ciba Specialty Chemicals, Inc. (BASF Corporation).

As for the radical polymerization initiator, specifically, an alkylphenone-based photopolymerization initiator (Irgacure 651, Irgacure 184, DAROCURE 1173, Irgacure 2959, Irgacure 127, DAROCURE MBF, Irgacure 907, Irgacure 369, Irgacure 379EG), an acylphosphine oxide-based photopolymerization initiator (Irgacure 819, LUCIRIN TPO), and others (Irgacure 784, Irgacure OXE01, Irgacure OXE02, Irgacure 754) may be used.

The addition amount of the radical polymerization initiator preferably ranges from 0.1% to 10% by mass, more preferably from 1% to 5% by mass and further preferably 2% to 4% by mass, based on 100% by mass of the total solid content of the hard coat layer forming composition of the present invention. The radical initiator may be used alone or in combination of two or more kinds thereof

### [Cationic Polymerization Initiator]

The hard coat layer forming composition in the present invention may further contain a cationic polymerization initiator.

As for the cationic polymerization initiator, conventionally known compounds and their mixtures such as a photoinitiator for photocation polymerization, an optical decolorizer for dyes, a photochromic agent, or a conventionally known acid generator used for micro resist or the like may be exemplified.

For example, an onium compound, an organic halogen compound, and a disulfone compound may be exemplified. Specific examples of the organic halogen compound, and the disulfone compound may be the same as those described in the radical generating compound as described above.

As for the onium compound, a diazonium salt, an ammonium salt, an iminium salt, a phosphonium salt, an iodonium salt, a sulfonium salt, an arsonium salt, and a selenonium salt may be exemplified. For example, the compounds described in paragraphs [0058] to [0059] in Japanese Patent Application Laid-Open No. 2002-29162 may be exemplified.

In the present invention, as for a particularly preferable cationic polymerization initiator, an anium salt may be exemplified. A diazonium salt, an iodonium salt, a sulfonium salt and an iminium salt are preferred in view of optical sensitivity of the photopolymerization initiator, and material stability of the compound, and among them, an iodonium salt is most preferred in view of lightfastness.

In the present invention, specific examples of the anium salt to be suitably used may include amylated sulfonium salt described in paragraph [0035] of Japanese Patent Application Laid-Open No. H9-268205, a diaryl iodonium salt or a triaryl sulfonium salt described in paragraphs [0010] to [0011] of Japanese Patent Application Laid-Open No. 2000-71366, a sulfonium salt of thiobenzoic acid S-phenyl ester described in paragraph [0017] of Japanese Patent Application Laid-Open No. 2001-288205, and an anium salt described in paragraphs [0030] to [0033] of Japanese Patent Application Laid-Open No. 2001-133696.

Other examples may include compounds described in paragraphs [0059] to [0062] of Japanese Patent Application Laid-Open No. 2002-29162 such as organic metal/organic halides, a photoacid generator having an o-nitrobenzylic protecting group, and a compound which generates a sulfonic acid through photolysis (e.g., imino sulfonate).

As for specific compounds of an iodonium salt-based cationic polymerization initiator, B2380 (manufactured by Tokyo Chemical Industry Co., LTD.), BBI-102 (manufactured by Midori Kagaku Co., LTD.), WPI-113 (manufactured by Wako Pure Chemical Industries, LTD.), WPI-124 (manufactured by Wako Pure Chemical Industries, LTD.), WPI-169 (manufactured by Wako Pure Chemical Industries, Ltd.), WPI-170 (manufactured by Wako Pure Chemical Industries, LTD.), and DTBPI-PFBS (manufactured by Toyo Gosei Co., LTD.) may be used.

Moreover, the following compounds FK-1 and FK-2 can be exemplified as preferred examples of the iodonium salt-based cationic polymerization initiator.

### Photocationic Polymerization Initiator (Iodonium Salt Compound) FK-1:

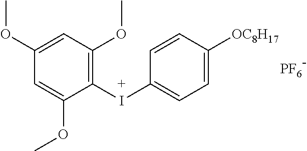

### Photocationic Polymerization Initiator (Iodonium Salt Compound) FK-2:

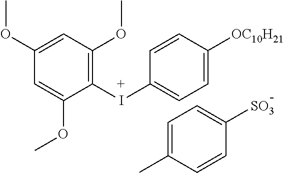

The cationic polymerization initiator may be used alone or in combination of two or more kinds thereof.

The cationic polymerization initiator may be added preferably in a range of 0.1% to 10% by mass, and more preferably in a ratio of 0.5% to 3.0% by mass, based on 100% by mass of the total solid content of the hard coat layer forming composition of the present invention. The addition amount in the above described range is preferred in view of stability of a curable composition, and polymerization reactivity.

### [UV Absorber]

The hard coat layer forming composition of the present invention may further contain a UV absorber.

The UV absorber contributes to improvement of durability of a film. Particularly, in an aspect that a polarizing plate protective film of the present invention is used as a surface protective film of an image display device, addition of the UV absorber is effective. The function of UV absorptivity may be given to only the transparent support. However, when the transparent support becomes thin, the function may be reduced, and thus, preferably, the UV absorptivity may be given to the hard coat layer. There is no particular limitation in the UV absorber usable in the present invention, and compounds described in paragraphs [0107] to [0185] of Japanese Patent Application Laid-Open No. 2006-184874 may be used. A polymer UV absorber may also be preferably used, and particularly, a polymer UV absorber described in Japanese Patent Application Laid-Open No. H6-148430 is preferably used.

The use amount of the UV absorber is varied according to the kinds of a compound, and usage conditions. Based on 100% by mass of the total solid content of the hard coat layer forming composition of the present invention, preferably, the UV absorber is included in a ratio of 0.1% to 10% by mass.

When the UV absorber is used, it is preferable that the kinds of the radical polymerization initiators are combined such that the absorption wavelengths of the UV absorber and the radical initiator do not overlap. Specifically, phosphine oxide-based compounds having absorption in a long wave such as bis(2,4,6-trimethylbenzoyl)-phenylphosphine oxide (e.g., IRGACURE 819 manufactured by BASF), bis(2,6-dimethoxybenzoyl)-2,4,4-trimethyl-pentylphosphine oxide, 2,4,6-trimethylbenzoyl-diphenyl-phosphine oxide (e.g., LUCIRIN TPO manufactured by BASF) are preferred. By using the radical initiator, a curing inhibition due to the UV absorber may be suppressed. Preferably, the kinds of the cationic polymerization initiator may be combined with IRGACURE PAG 103, IRGACURE PAG 121, CGI725 which have absorption in a long wave.

Other than the combination of the UV absorber with the initiator having absorption in a long wave, preferably, a curing accelerator (sensitizer) may be used in combination. Through combination of the sensitizer, the addition amount of the polymerization initiator may be reduced, or a range of a material selection may be widened. As for the sensitizer to be used in combination, as specific examples of a photosensitizer, for example, n-butylamine, triethylamine, tri-n-butyl phosphine, Michler's ketone, thioxanthone, anthracene, diphenylbutadiene, and distyrylbenzene, acridone may be used.

### [Solvent]

The hard coat layer forming composition of the present invention may contain a solvent. As for the solvent, various solvents selected in terms of a capability of dissolving or dispersing the respective components, having a uniform surface shape in a coating step and a drying step, securing a liquid preservability, and having a moderate saturation vapor pressure may be used.

The solvent may be used in combination of two or more kinds thereof. Particularly, in view of a drying load, it is preferable that a solvent having a boiling point of 100° C. or less at a normal pressure and a room temperature is contained as a main component, and a solvent having a boiling point higher than 100° C. is contained in a small amount in order to adjust a drying rate.

In the hard coat layer forming composition of the present invention, in order to prevent sedimentation of particles, it is preferable that a solvent having a boiling point of 80° C. or less is contained in a range of 30% to 80% by mass based on the total solvent of the coating composition, and more preferably in a range of 50% to 70% by mass. When the solvent having a boiling point of 80° C. or less is contained in the ratio above, a resin component may be properly suppressed from penetrating a transparent support, and a viscosity increase rate due to drying is increased so that particle sedimentation may be suppressed.

Examples of the solvent having a boiling point of 100° C. or less may include hydrocarbons such as hexane (boiling point 68.7° C.), heptane (98.4° C.), cyclohexane (80.7° C.), benzene (80.1° C.), halogenated hydrocarbons such as dichloromethane (39.8° C.), chloroform (61.2° C.), carbon tetrachloride (76.8° C.), 1,2-dichloroethane (83.5° C.), trichloroethylene (87.2° C.), ethers such as diethylether (34.6° C.), diisopropylether (68.5° C.), dipropylether (90.5° C.), tetrahydrofuran (66° C.), esters such as ethyl formate (54.2° C.), methyl acetate (57.8° C.), ethyl acetate (77.1° C.), isopropyl acetate (89° C.), ketones such as acetone (56.1° C.), 2-butanone (same as methylethylketone, 79.6° C.), alcohols such as methanol (64.5° C.), ethanol (78.3° C.), 2-propanol (82.4° C.), 1-propanol (97.2° C.), cyano compounds such as acetonitrile (81.6° C.), propionitrile (97.4° C.), and carbon disulfide (46.2° C.). Among them, ketones and esters are preferred, and ketones are particularly preferred. among ketones, 2-butanone is particularly preferred.

Examples of the solvent having a boiling point higher than 100° C. may include octane (125.7° C.), toluene (110.6° C.), xylene (138° C.), tetrachloroethylene(121.2° C.), chlorobenzene (131.7° C.), dioxane (101.3° C.), dibutylether (142.4° C.), isobutyl acetate (118° C.), cyclohexanone (155.7° C.), 2-methyl-4-pentanone (same as MIBK, 115.9° C.), 1-butanol (117.7° C.), N,N-dimethylformamide (153° C.), N,N-dimethylacetamide (166° C.), and dimethyl sulfoxide (189° C.). Preferably, cyclohexanone, and 2-methyl-4-pentanone may be exemplified.

The solid content concentration of the hard coat layer forming composition of the present invention preferably ranges from 20% to 60% by mass, and more preferably from 30% to 50% by mass.

### (Mat Particles)

The hard coat layer may contain mat particles having an average particle diameter in a range of 1.0 μm to 10.0 μm, and preferably in a range of 1.5 μm to 5.0 μm in order to impart an internal scattering property or a surface unevenness. Also, in order to adjust the viscosity of a coating liquid, a polymer compound or an inorganic layered compound may be contained. The inorganic fine particles (c) may be used as mat particles.

### [Transparent Support]

As for the transparent support of the polarizing plate protective film of the present invention, a transparent substrate film is preferred. Examples of the transparent substrate film may include a transparent resin film, a transparent resin plate, a transparent resin sheet and a transparent glass, but are not particularly limited thereto. Examples of the transparent resin film may include a cellulose acylate film (e.g., a cellulose triacetate film (refractive index 1.48), a cellulose diacetate film, a cellulose acetate butyrate film, a cellulose acetate propionate film), a polyethylene terephthalate film, a polyethersulfone film, a polyacrylic resin film, a polyurethane resin film, a polyester film, a polycarbonate film, a polysulfone film, a polyether film, a polymethylpentene film, a polyether ketone film, a (meth) acrylonitrile film, a polyolefin, a polymer having an alicyclic structure (norbornene resin (Arton: product name, manufactured by JSR, amorphous polyolefin (ZEONEX, product name, manufactured by Zeon Corporation)), and the like. Among them, a cellulose acylate film, a polyethylene terephthalate film, and a polymer having an alicyclic structure are preferred, and particularly, a cellulose acylate film is preferred.

The thickness of the transparent support is 40 μm or less, preferably 30 μm or less, and more preferably 25 μm or less. When the thickness of the transparent support is small, the thickness of the film in its entirety may be reduced. Meanwhile, when the thickness of the support is small, the manufacturing thereof may be difficult in view of a surface form or uniformity. Thus, the thickness is preferably 5 μm or more, and more preferably 10 μm or more.

### [Configuration of Polarizing Plate Protective Film]

In the simplest configuration of the polarizing plate protective film of the present invention, generally, a hard coat layer is coated on a transparent support.

Preferred examples of layer configuration of the polarizing plate protective film of the present invention are described below, but are not particularly limited thereto.

support/hard coat layer

support/hard coat layer/low refractive index layer

support/hard coat layer/antiglare layer(antistatic layer)/low refractive index layer

support/hard coat layer/antiglare layer/antistatic layer/low refractive index layer

support/hard coat layer/antistatic layer/antiglare layer/low refractive index layer

support/hard coat layer(antistatic layer)/antiglare layer/low refractive index layer

support/hard coat layer/high refractive index layer/antistatic layer/low refractive index layer

support/hard coat layer/high refractive index layer(antistatic layer)/low refractive index layer

support/hard coat layer/antistatic layer/high refractive index layer/low refractive index layer

support/hard coat layer/middle refractive index layer/high refractive index layer(antistatic layer)/low refractive index layer

support/hard coat layer/middle refractive index layer(antistatic layer)/high refractive index layer/low refractive index layer

support/hard coat layer(antistatic layer)/middle refractive index layer/high refractive index layer/low refractive index layer

support/antistatic layer/hard coat layer/middle refractive index layer/high refractive index layer/low refractive index layer

antistatic layer/support/hard coat layer/middle refractive index layer/high refractive index layer/low refractive index layer

Here, the antistatic layer and the antiglare layer may have a hard coat property.

The film thickness of the hard coat layer of the present invention ranges from 3 μm to 15 μm, and preferably from 3 μm to 10 μm.

### [Low Refractive Index Layer]

In the present invention, a low refractive index layer may be formed on the hard coat layer in order to impart a reflectivity reducing effect. The low refractive index layer has a lower refractive index than the hard coat layer, and its thickness preferably ranges from 50 nm to 200 nm, more preferably from 70 nm to 150 nm, and most preferably from 80 nm to 120 nm.

The refractive index of the low refractive index layer is lower than a refractive index of a layer just below the low refractive index layer, and preferably ranges from 1.20 to 1.55, more preferably from 1.25 to 1.46, and particularly preferably from 1.30 to 1.40. The thickness of the low refractive index layer preferably ranges from 50 nm to 200 nm, and more preferably from 70 nm to 100 nm. Preferably, the low refractive index layer is obtained by curing a curable composition for forming the low refractive index layer.

Preferred aspects of the curable composition for a low refractive index layer may include:

(1) a composition containing a fluorine-containing compound having a crosslinking or polymerizable functional group,
(2) a composition consisting mainly of a hydrolyzed condensate of a fluorine-containing organosilane material, and
(3) a composition containing a monomer having two or more ethylenically unsaturated groups, and inorganic fine particles (particularly, preferably, hollow inorganic fine particles.

Compositions (1) and (2) may preferably contain inorganic fine particles. Also, the use of the hollow inorganic fine particles having a low refractive index is particularly preferred in view of achievement of a low refractive index, and adjustment of an addition amount of the inorganic fine particles and the refractive index.

### (1) A Fluorine-Containing Compound Having a Crosslinking or Polymerizable Functional Group

As for the fluorine-containing compound having a crosslinking or polymerizable functional group, a copolymer of a fluorine-containing monomer and a monomer having a crosslinkable or polymerizable functional group may be exemplified. Specific examples of the fluorine-containing polymer are described in Japanese Patent Application Laid-Open Nos. 2003-222702, and 2003-183322.

The polymer may be used in combination with a curing agent having a proper polymerizable unsaturated group as described in Japanese Patent Application Laid-Open No. 2000-17028. As described in Japanese Patent Application Laid-Open No. 2002-145952, the polymer may be preferably used in combination with a fluorine-containing compound having a polyfunctional polymerizable unsaturated group. As for the compound having a polyfunctional polymerizable unsaturated group, a monomer having two or more ethylenically unsaturated groups, which has been described as a curable resin compound of the antiglare layer, may be exemplified. A hydrolytic condensate of organosilane described in Japanese Patent Application Laid-Open No. 2004-170901 is preferred, and particularly, a hydrolytic condensate of organosilane containing a (meth)acryloyl group is preferred. These compounds are preferable due to its high combining effect on a scratch resistance improvement especially when a compound having a polymerizable unsaturated group is used for a polymer body.

When a polymer itself independently has no sufficient curability, a crosslinking compound may be blended to impart a required curability. For example, when a hydroxyl group is contained in a polymer body, various amino compounds may be preferably used as curing agents. An amino compound used as the crosslinking compound is a compound containing two or more groups in total, which include either or both of a hydroxyalkylamino group or/and an alkoxy alkylamino group, and specifically, a melamine-based compound, an urea compound, a benzoguanamine based compound, and a glycoluril based compound may be exemplified. In curing of these compounds, an organic acid or a salt thereof may be preferably used.

### (2) A Composition Consisting Mainly of a Hydrolyzed Condensate of a Fluorine-Containing Organosilane Material

A composition consisting mainly of a hydrolyzed condensate of a fluorine-containing organosilane compound is also preferred due to its low refractive index, and a high coating film surface hardness. A condensate of tetraalkoxysilane and a compound containing hydrolyzable silanol at one or both ends to a fluorinated alkyl group is preferred. Specific compositions are described in Japanese Patent Application Laid-Open No. 2002-265866, and Japanese Patent No. 317152.

### (3) Composition Containing a Monomer Having Two or More Ethylenically Unsaturated Groups, and Hollow Inorganic Fine Particles

According to another preferred aspect, there may be a low refractive index layer composed of low refractive index particles and a binder. The low refractive index particles may be organic or inorganic, but particles having pores therein are preferred. Specific examples of the hollow particles are exemplified as silica-based particles described in Japanese Patent Application Laid-Open No. 2002-79616. The refractive index of the particles preferably ranges from 1.15 to 1.40, and more preferably from 1.20 to 1.30. As for the binder, the monomer having two or more ethylenically unsaturated groups, which has been mentioned in the page for the antiglare layer, may be exemplified.

To the composition for the low refractive index layer used in the present invention, preferably, the photoradical polymerization initiator or the thermal radical polymerization initiator as described above may be added. When a radical polymerizable compound is contained, the polymerization initiator may be used in a range of 1 parts to 10 parts by mass with respect to the compound, preferably in a range of 1 parts to 5 parts by mass.

The low refractive index layer used in the present invention may be used in combination with inorganic particles. In order to impart a scratch resistance, fine particles having a particle diameter in a range of 15% to 150% with respect to a low refractive index layer thickness, preferably of 30% to 100%, and further preferably of 45% to 60% may be used.

To the low refractive index layer of the present invention, for example, a conventionally known polysiloxane-based or fluorine-based antifouling agent, and a slipping agent may be properly added in order to impart characteristics such as an antifouling property, a water resistance, a chemical resistance, a slipperiness.

As for the additive having a polysiloxane structure, a reactive group-containing polysiloxane (e.g., “KF-100T”, “X-22-169AS”, “KF-102”, “X-22-3701IE”, “X-22-164B”, “X-22-5002”, “X-22-173B”, “X-22-174D”, “X-22-167B”, “X-22-161AS” (product names), manufactured by Shin-Etsu Chemical Co., LTD.; “AK-5”, “AK-30”, “AK-32” (product names), manufactured by TOAGOSEI CO., LTD.; “Silaplane FM0725”, “Silaplane FM0721” (product names), manufactured by CHISSO CORPORATION) may be preferably added. Silicon compounds described in Tables 2 and 3 of Japanese Patent Application Laid-Open No. 2003-112383 may also be preferably used.

As for the fluorine-based compound, a compound having a fluoroalkyl group is preferred. The fluoroalkyl group preferably has 1 to 20 carbon atoms, and more preferably 1 to 10 carbon atoms, and may have a linear structure (e.g., —CF₂CF₃, —CH₂(CF₂)₄H, —CH₂(CF₂)₈CF₃, —CH₂CH₂(CF₂)₄H), a branched structure (e.g., CH(CF₃)₂, CH₂CF(CF₃)₂, CH(CH₃)CF₂CF₃, CH(CH₃)(CF₂)₅CF₂H), or an alicyclic structure (preferably, a 5-membered or 6-membered ring, e.g., a perfluorocyclohexyl group, a perfluorocyclopentyl group or an alkyl group substituted by these). The fluoroalkyl group may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of fluoroalkyl groups described above may be contained in the same molecule.

The fluorine-based compound preferably has a substituent which contributes to the bond formation or compatibility with the low refractive index layer film. The above substituents may be the same or different, and a plurality of substituents may be preferably present. Preferred examples of the substituent may include an acryloyl group, a methacryloyl group, a vinyl group, an aryl group, a cinnamoyl group, an epoxy group, an oxetanyl group, a hydroxyl group, a polyoxy alkylene group, a carboxyl group, an amino group. The fluorine-based compound may be an oligomer or a polymer with a compound containing no fluorine atom, and there is no particular limitation in the molecular weight. The fluorine atom content of the fluorine compound is not particularly limited, but is preferably 20% by mass or more, and particularly preferably ranges from 30% to 70% by mass, and most preferably from 40% to 70% by mass. Preferred examples of the fluorine compound may include R-2020, M-2020, R-3833, M-3833, OPTOOL DAC (product names) manufactured by Daikin Industries, LTD., and MEGAFAC F-171, F-172, F-179 A, DEFENSA MCF-300, MCF-323 (product names) manufactured by DIC Corporation, but are not limited thereto.

The polysiloxane fluorine-based compound or the compound having a polysiloxane structure is preferably added in a range of 0.1% to 10% by mass with respect to the total solid content of the low refractive index layer, and particularly preferably in a range of 1% to 5% by mass.

### [Application Method]

Formation of each layer of the polarizing plate protective film of the present invention may be perfoimed by the following coating methods, but is not limited to these methods. Conventionally known methods such as a dip coating method, an air knife coating method, a curtain coating method, a roller coating method, a wire bar coating method, a gravure coating method, a slide coating method, an extrusion coating method (die coating method) (See, Japanese Patent Application Laid-Open No. 2003-164788), and a micro gravure coating method may be used, and among them, a micro gravure coating method, and a die coating method are preferred.

### [Drying and Curing Conditions]

When a layer is formed by coating as in a hard coat layer in the present invention, preferred examples of drying and curing methods will be described below.

In the present invention, it is effective that the curing is performed by a combination of irradiation with ionizing radiation, with a heat treatment prior to, simultaneously with or after the irradiation.

Hereinafter, several patterns of a manufacturing process will be described, but not limited thereto.

(hereinafter, “-” indicates that there is no heat treatment)

prior to irradiation→simultaneously with irradiation→after irradiation

(1) heat treatment→ionizing radiation curing→-
(2) heat treatment→ionizing radiation curing→heat treatment
(3) -→ionizing radiation curing→heat treatment

Further, a step of performing heat treatment simultaneously with ionizing radiation curing is also preferred.

In the present invention, as described above, the heat treatment is preferably performed in combination with the irradiation with ionizing radiation. The temperature for the heat treatment is not particularly limited as long as a structure layer containing a support and a hard coat layer of the polarizing plate protective film is not impaired, but preferably ranges from 40° C. to 150° C., and more preferably from 40° C. to 80° C.

The time for the heat treatment is varied according to, for example, the molecular weight of the used components, the interaction with other ingredients, and the viscosity, but ranges from 15 sec to 1 hour, preferably from 20 sec to 30 min, and most preferably from 30 sec to 5 min.

The type of the ionizing radiation is not particularly limited, and X-rays, electron beam, ultraviolet rays, visible light, and infrared rays may be exemplified, and the ultraviolet rays are widely used. For example, when the coating film is UV-curable, it is preferred to cure each layer by irradiating ultraviolet rays in an irradiation amount of 10 mJ/cm² to 1000 mJ/cm² by an ultraviolet lamp. During the irradiation, the energy may be applied at a time, or may be irradiated in divided stages. Particularly, in terms of reducing the performance difference in the plane of the coating film, or improving the curling, it is preferable that the irradiation is performed in two or more divided stages, and it is preferable to irradiate an ultraviolet light in a low irradiation dose of 150 mJ/cm² or less in an initial stage, and then to irradiate an ultraviolet light in a high irradiation dose of 50 mJ/cm² or more, and also preferable to irradiate the light in a higher irradiation dose in a later stage than that in an initial stage.

### <Method of Manufacturing Polarizing Plate Protective Film>

In the method of manufacturing a polarizing plate protective film of the present invention,

a polarizing plate protective film which has a transparent support with a thickness of 40 μm or less, and a hard coat layer with a film thickness ranging from 3 μm to 15 μm is manufactured,

in which the hard coat layer is a layer formed by curing a hard coat layer forming composition including at least compounds (a) and (b) below compound, and

the hard coat layer forming composition contains the compound (a) in an amount of 5% to 40% by mass and the compound (b) in an amount of 40% by mass to 95% by mass, based on 100% by mass of the total solid content of the hard coat layer forming composition.

The compound (a) has a repeating unit represented by Formula (1) below and has a weight average molecular weight of 1500 or more.

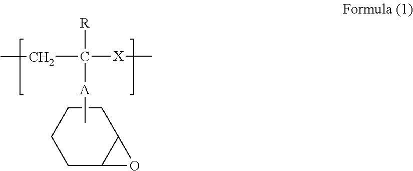

In Formula (1), R represents a hydrogen atom or a methyl group,

X represents a single bond, or an oxygen atom, an alkylene group which may have a substituent, an arylene group which may have a substituent, an aralkylene group which may have a substituent, an ester bond, a carbonyl bond, —NH— or a linking group composed of a combination of these,

A represents a single bond, or an alkylene group which may have a substituent, an arylene group which may have a substituent, an aralkylene group which may have a substituent, an ester bond, an ether bond, a carbonyl bond, —NH— or a linking group composed of a combination of these.

The compound (b) has three or more ethylenically unsaturated double bonding groups in the molecule.

### [Polarizing Plate]

The polarizing plate protective film of the present invention may be used as one side protective film or both side protective films in a polarizing plate constituted by a polarizing film and protective films arranged on both sides thereof so that the polarizing plate may have a hard coat property.

As for one side protective film, the polarizing plate protective film of the present invention may be used, and as for the other side protective film, a transparent support used for the polarizing plate protective film may be used, but a conventional cellulose acetate film may be used. As for the other side protective film, a cellulose acetate film which is manufactured by a solution casting method and is stretched in a width direction in a roll film form at a stretching ratio of 10% to 100% may be preferably used.

According to a preferred aspect, among the two protective films of the polarizing film, a film other than the polarizing plate protective film of the present invention may be an optical compensatory film having an optical compensatory layer composed of an optically anisotropic layer. The optical compensatory film (phase difference film) may improve the viewing angle characteristic of a liquid crystal display screen. As for the optical compensatory film, a conventionally known film may be used, but in view of widening the viewing angle, an optical compensatory film described in Japanese Patent Application Laid-Open No. 2001-100042 is preferred.

### <Polarizer>

A polarizer used for the polarizing plate of the present invention will be described.

The polarizer that may be used in the polarizing plate of the present invention may be preferably composed of a polyvinyl alcohol (PVA) and a dichroic molecule, and as described in Japanese Patent Application Laid-Open No. H11-248937, a polyvinylene-based polarizer obtained by producing a polyene structure through dehydration and dechlorination of PVA or polyvinyl chloride and orienting the structure may also be used.

### (PVA)

The PVA is preferably a polymer material obtained by saponifying polyvinyl acetate, and may contain a component capable of copolymerizing with, for example, vinyl acetate such as vinylethers, unsaturated carboxylic acid, unsaturated sulfonic acid, and olefins. Also, a modified PVA containing, for example, an acetoacetyl group, a sulfonic acid group, a carboxyl group, or an oxyalkylene group may also be used.

Other than these, in the polarizing plate of the present invention, a PVA film having a 1,2-glycol bond amount of 1.5 mol % or less which is described in Japanese Patent No. 3021494, a PVA film described in Japanese Patent Application Laid-Open No. 2001-316492 where the number of optical foreign matters of 5 μm or more is 500 or less per 100 cm², a PVA film described in Japanese Patent Application Laid-Open No. 2002-030163 where an unevenness of the hot water cutting temperature in the TD direction of the film is 1.5° C. or less, and a PVA film formed from a solution in which 3 to 6-valent polyhydric alcohol such as glycerin is mixed in an amount of 1% to 100% by mass, or a solution in which a plasticizer described in Japanese Patent Application Laid-Open No. H06-289225 is mixed in an amount of 15% by mass or more, may be preferably used.

### (Dichroic Molecule)

As for the dichroic molecule, a higher iodine ion such as I₃⁻ or I₅⁻ or a dichroic dye may be preferably used.

In the present invention, a higher iodine ion is particularly preferably used. As described in “Application of Polarizing Plate” (edited by Ryo Nagata, CMC Publishing Co., Ltd.), or in “industrial Materials” Vol. 28, No. 7, pp. 39-45, the higher iodine ion may be produced in the state of being adsorbed to PVA or oriented after dipping PVA in a liquid comprising an aqueous potassium iodide solution having iodine dissolved therein and/or in an aqueous boric acid solution.

In the case of using a dichroic dye as the dichroic molecule, an azo-based coloring pigment is preferred, and a bisazo-based or trisazo-based coloring pigment is more preferred. The dichroic dye is preferably water-soluble and therefore, is preferably used in the form of a free acid, an alkaline metal salt, an ammonium salt or an amine salt by introducing a hydrophilic substituent such as a sulfonic acid group, an amino group or a hydroxyl group into the dichroic molecule. Specific examples of such a dichroic dye may include those described in Japanese Patent Application Laid-Open No. 2007-086748.

### (Boric Acid)

In the polarizing plate of the present invention, the polarizer may preferably contain a boric acid as for a cross-linking agent. By cross-linking the polarizer with the boric acid, the stability of the complex formed from a dichroic molecule and PVA is improved, thereby suppressing the polarization performance degradation under conditions of a high temperature and a high humidity. In the polarizing plate of the present invention, the content of boric acid in the polarizer preferably ranges from 1 parts to 100 parts by mass, and preferably from 5 parts to 50 parts by mass with respect to 100 parts by mass of the polarizer. It is possible to prepare a polarizer with a tint balance by controlling the content of boric acid in the above range.

In the polarizing plate of the present invention, the reduction rate of the boric acid in the polarizer before and after the elapse of time of 1000 hours at 60° C. and RH 95% is preferably 50% or less. The reduction rate of the boric acid is preferably 40% or less, and more preferably 30% or less.

### (Film Thickness of Polarizer)

Before the polarizer is stretched, the film thickness of a film is not particularly limited, but preferably ranges from 1 μm to 1 mm, and particularly preferably from 10 μm to 200 μm in view of the stability of film holding, and the uniformity of stretching. Also, as described in Japanese Patent Application Laid-Open No. 2002-236212, a thin PVA film in which a stress generated through stretching at a ratio of 4 to 6 times in water is 10 N or less may be used.

After the polarizer in the present invention is stretched, the thickness preferably ranges from 3 μm to 25 μm. more preferably from 3 μm to 15 μm, and most preferably from 3 μm to 10 μm. When the thickness of the polarizer is set to the above described range, it is possible to reduce the warpage or distortion of the liquid crystal panel due to environmental humidity.

### (Thickness of Polarizing Plate)

The thickness of the polarizing plate in the present invention preferably ranges from 15 μm to 150 μm. more preferably from 15 μm to 120 μm, and further preferably from 15 μm to 90 μm. When the thickness of the polarizing plate is set to the above described range, it is possible to reduce the warpage or distortion of the liquid crystal panel due to environmental humidity.

### <Method of Manufacturing Polarizer>

The method of manufacturing the polarizer is not particularly limited, but, for example, preferably, after the PVA is made into a film, a dichroic molecule may be introduced to constitute a polarizer. The PVA film may be prepared by referring to, for example, a method described in [0213] to [0237] of Japanese Patent Application Laid-Open No. 2007-86748, Japanese Registered Patent No. 3342516, Japanese Patent Application Laid-Open No. H09-328593, Japanese Patent Application Laid-Open No. 2001-302817, Japanese Patent Application Laid-Open No. 2002-144401.

Specifically, particularly preferably, in the method of manufacturing the polarizer, a PVA-based resin solution preparation step, a casting step, a swelling step, a dyeing step, a hardening step, a stretching step, and a drying step may be successively carried out in this order. Also, during or after these steps, an on-line surface inspection step may be provided.

### (Preparation of PVA-Based Resin Solution)

In the PVA-based resin solution preparation step, it is preferable to prepare a stock solution with a PVA-based resin dissolved in water or an organic solvent. The concentration of the polyvinyl alcohol-based resin in the stock solution preferably ranges from 5% to 20% by mass. For example, in a preferred method, a wet cake of PVA is placed in a dissolving tank, a plasticizer and water are added thereto if necessary, and stirring is performed by blowing steam from the tank bottom. The internal resin temperature is preferably warmed to a range of 50° C. to 150° C., and the inside of the system may be pressurized.

An acid may or may not be added to the polarizer. In a case of addition, the acid is preferably added in this step. Meanwhile, when the acid is added to the polarizer, the same as the compound (a) included in the first polarizing plate protective film may be used.

### (Casting)

In the casting step, generally preferably, a method of forming a film by casting the PVA-based resin stock solution prepared as described above is used. There is no particular limitation in the casting method, but preferably, a heated PVA-based resin stock solution is supplied to a biaxial extruder, and casted from a discharging unit (preferably, a die, more preferably, a T-shaped slit die) on a support by a gear pump to form a film. Furthermore, the temperature of the resin solution discharged from the die is not particularly limited.

As for the support, a cast drum is preferred, and there is no particular limitation in the diameter, width, rotation speed, and surface temperature of the drum. Then, it is preferred that the drying is performed by alternately passing the back surface and the front surface of an obtained roll through a drying roll.

### (Swelling)

The swelling step is preferably performed using only water, but as described in Japanese Patent Application Laid-Open No. H10-153709, the swelling degree of the polarizing plate substrate may be controlled by swelling the polarizing plate substrate with an aqueous boric acid solution so as to improve the optical performance stability and prevent wrinkling of the polarizing plate substrate in the production line.

The temperature and time of the swelling step may be arbitrarily selected but preferably, the temperature ranges from 10° C. to 60° C., and the time ranges from 5 sec to 2000 sec.

Meanwhile, during the swelling step, stretching may be slightly carried out, and, for example, preferably may be carried out by about 1.3 times.

### (Dyeing)

The dyeing step may be performed using the method described in Japanese Patent Application Laid-Open No. 2002-86554. As for the dyeing method, not only dipping but also an arbitrary method such as applying or spraying of an iodine or dye solution may be employed. Furthermore, as described in Japanese Patent Application Laid-Open No. 2002-290025, a method of performing the dyeing while stirring the solution in the bath under the control of the iodine concentration, dyeing bath temperature and stretch ratio in the bath may be employed.

In the case of using a higher iodine ion as the dichroic molecule, the dyeing step is preferably performed using a solution prepared by dissolving iodine in an aqueous potassium iodide solution so as to obtain a high-contrast polarizing plate. In this case, the mass ratio between iodine and potassium iodide in the iodine-aqueous potassium iodide solution may be the same as described in Japanese Patent Application Laid-Open No. 2007-086748. Also, as described in Japanese Registered Patent No. 3145747, a boron-based compound such as boric acid or borax may be added to the dyeing solution.

### (Hardening)

The hardening step, the film is preferably dipped in a crosslinking agent solution or coated with the solution, thereby incorporating a crosslinking agent into the film. Furthermore, as described in Japanese Patent Application Laid-Open No. H11-52130, the hardening step may be performed in several divided stages.

As for the crosslinking agent, those described in U.S. Reissue Pat. No. 232,897 may be used. A polyvalent aldehyde may be used as the crosslinking agent for enhancing the dimensional stability as described in the specification of Japanese Patent 3,357,109, but boric acids are most preferred. In the case of using the boric acid as the crosslinking agent in the hardening step, a metal ion may be added to the aqueous boric acid-potassium iodide solution. The metal ion is preferably zinc chloride, but as described in Japanese Patent Application Laid-Open No. 2000-35512, a zinc halide such as zinc iodide, or a zinc salt such as zinc sulfate or zinc acetate may be used instead of zinc chloride.

Also, hardening may be performed by preparing an aqueous boric acid-potassium iodide solution in which zinc chloride is added and dipping a PVA film therein, and a method described in Japanese Patent Application Laid-Open No. 2007-086748 may be used.

Meanwhile, here, as for a method of improving a durability in a high temperature environment, the conventionally known immersion treatment with an acidic solution may or may not be performed. Examples of the treatment with an acidic solution may include the methods described in Japanese Patent Application Laid-Open No. 2001-83329, Japanese Patent Application Laid-Open No. H6-254958, and International Publication Pamphlet No. WO2006/095815.

### (Stretching)

In the stretching step, a vertical uniaxial stretching method described, for example, in U.S. Pat. No. 2,454,515, or a tenter method described in Japanese Patent Application Laid-Open No. 2002-86554 may be preferably used. The stretch ratio is preferably from 2 to 12 times, more preferably from 3 to 10 times. It is also preferred that the relationship of the stretch ratio, the thickness of the original film and the polarizer thickness may satisfy (film thickness of polarizer after lamination of protective film/thickness of original film)×(total raw ratio)>0.17 as described in Japanese Patent Application Laid-Open No. 2002-040256, or the relationship of the width of the polarizer after taken out from the final bath and the width of the polarizer at the lamination of the protective film may satisfy 0.80≦(width of polarizer at lamination of protective film/width of polarizer after taken out from final bath)≦0.95 as described in Japanese Patent Application Laid-Open No. 2002-040247.

### (Drying)

In the drying step, a known method described in Japanese Patent Application Laid-Open No. 2002-86554 may be used, but the drying temperature preferably ranges from 30° C. to 100° C., and the drying time preferably ranges from 30 sec to 60 min. It is also preferred to perform a heat treatment for adjusting the in-water discoloring temperature to 50° C. or more as described in Japanese Registered Patent No. 3148513 or perform the aging in an atmosphere having controlled temperature and humidity as described in Japanese Patent Application Laid-Open No. H07-325215 or Japanese Patent Application Laid-Open No. H07-325218.

By this step, the polarizer with a film thickness of 10 μm to 200 μm may be preferably prepared. Meanwhile, the control for the film thickness may be performed by a conventionally known method, and performed by setting, for example, a die slit width or a stretching condition in the casting step to appropriate values.

In bonding the polarizing plate protective film in the polarizing plate of the present invention to the polarizer, it is preferred that they are bonded to each other such that the transmission axis of the polarizer and the slow axis of the polarizing plate protective film are substantially parallel to each other.

Here, “substantially parallel” indicates that a deviation between the direction of a main refractive index nx of the polarizing plate protective film containing the organic acid, and the transmission axis direction of the polarizing plate is less than 5° or less than 1°, and may be preferably less than 0.5°. The deviation of less than 1° is preferable because a polarization degree performance under a polarizing plate cross nicol state is hardly decreased, and a light leakage is unlikely to occur.

### [Image Display Device]

The polarizing plate protective film or the polarizing plate of the present invention may be employed in an image display device such as a liquid crystal display device (LCD).

In particularly, preferably, the liquid crystal display device includes a liquid crystal cell and a polarizing plate of the present invention which is disposed at least one side surface of the liquid crystal cell, and includes the polarizing plate protective film of the present invention disposed at the outermost surface.

### Example

The present invention will be described in detail with reference to the following examples, but is not limited thereto to the examples.

### (Preparation of Hard Coat Layer Coating Liquid)

Respective components were added in the composition described in Tables 1 and 2 below, and filtered through a polypropylene-made filter having a pore diameter of 10 μm to prepare coating liquids a01 to a17 and b01 to b06 for a hard coat layer. The value in Tables 1 and 2 is based on “% by mass of solids” of each component.

Like ELECOM V-8802, a material diluted with a solvent is also added while its solid content ratio is adjusted to be the values of Tables 1 and 2. In a case the solvent, the ratio of the solvent is adjusted to be the ratios of Tables 1 and 2 so that a coating liquid with a solid ratio of 35% by mass is prepared.

Also, a coating liquid al 8 (an antiglare hard coat layer coating liquid) for the hard coat layer was prepared as follows.

### <Preparation of Hard Coat Solution a18 for Antiglare Hard Coat Layer>

A hard coat solution A02 was mixed with smectite (Lucentite STN, manufactured by Co-op Chemical Co., LTD.) and cross-linking acrylic-styrene particles (average particle diameter 2.5 μm, refractive index 1.52) in a composition described in Table 1. Then, the mixture was filtered through a polypropylene-made filter having a pore diameter of 30 μm to prepare a coating liquid al 8 for an antiglare hard coat layer. Meanwhile, resin particles and smectite were added in a dispersed state.

TABLE 1

| | | Hard coat layer coating liquid | | | | | | | | |
|---|---|---|---|---|---|---|---|---|---|---|
| | | a01 | a02 | a03 | a04 | a05 | a06 | a07 | a08 | a09 |
| Compound (a) | Comparative compound 1 | | | | | | | | | |
| | Compound 2 | 5.00% | 10.00% | 22.00% | 40.00% | | | 15.00% | 15.00% | 15.00% |
| | Comparative compound 3 | | | | | | | | | |
| | UVR-6110 | | | | | | | | | |
| | Compound 4 | | | | | 22.00% | 40.00% | | | |
| | Compound 5 | | | | | | | | | |
| Compound (b) | DPHA | 91.70% | 86.45% | 74.95% | 56.45% | 74.45% | 56.45% | 71.95% | | 71.95% |
| | ATMMT | | | | | | | 10.00% | 10.00% | 10.00% |
| | UV1700B | | | | | | | | 71.95% | |
| Radical | IRGACURE127 | 3.00% | 3.00% | 2.00% | 1.50% | 3.00% | 1.50% | 2.50% | 2.50% | 2.50% |
| polymerization | | | | | | | | | | |
| initiator | | | | | | | | | | |
| Cationic | IRGACURE290 | | | | | | | 0.50% | 0.50% | |
| polymerization | IRGACURE270 | | | | | | | | | |
| initiator | FK-1 | | | | | | | | | 0.50% |
| | B2380 | 0.25% | 0.50% | 1.00% | 2.00% | 0.50% | 2.00% | | | |
| | CHI 725 | | | | | | | | | |
| Inorganic fine | ELECOM V-8802 | | | | | | | | | |
| particles (c) | ELECOM V-8803 | | | | | | | | | |
| | MiBK-ST | | | | | | | | | |
| Surfactant (d) | FP-1 | 0.05% | 0.05% | 0.05% | 0.05% | 0.05% | 0.05% | 0.05% | 0.05% | 0.05% |
| | Ftergent 710FM | | | | | | | | | |
| Other | Smectite | | | | | | | | | |
| compounds | Cross-linking acryl- | | | | | | | | | |
| | styrene particles | | | | | | | | | |
| Solvent | MEK | 50% | 50% | 50% | 50% | 50% | 50% | 50% | 50% | 50% |
| | MiBK | 30% | 30% | 30% | 30% | 30% | 30% | 30% | 30% | 30% |
| | Methyl acetate | 20% | 20% | 20% | 20% | 20% | 20% | 20% | 20% | 20% |
| Notes | | Example | Example | Example | Example | Example | Example | Example | Example | Example |
| | | Hard coat layer coating liquid | | | | | | | | |
| | | a10 | a11 | a12 | a13 | a14 | a15 | a16 | a17 | a18 |
| Compound (a) | Comparative compound 1 | | | | | | | | | |
| | Compound 2 | 15.00% | 15.00% | 15.00% | 15.00% | 15.00% | 15.00% | 15.00% | | 15.00% |
| | Comparative compound 3 | | | | | | | | | |
| | UVR-6110 | | | | | | | | | |
| | Compound 4 | | | | | | | | | |
| | Compound 5 | | | | | | | | 5.00% | |
| Compound (b) | DPHA | 71.95% | 71.95% | 71.95% | 56.95% | 56.95% | 56.95% | 56.95% | 66.70% | 72.95% |
| | ATMMT | 10.00% | 10.00% | 10.00% | 10.00% | 10.00% | 10.00% | 10.00% | 10.00% | |
| | UV1700B | | | | | | | | | |
| Radical | IRGACURE127 | 2.50% | 2.50% | 2.50% | 2.50% | 2.50% | 2.50% | 2.50% | 3.00% | 2.50% |
| polymerization | | | | | | | | | | |
| initiator | | | | | | | | | | |
| Cationic | IRGACURE290 | | | | | | | | | |
| polymerization | IRGACURE270 | 0.50% | | | | | | | | |
| initiator | FK-1 | | | | | | | | | |
| | B2380 | | 0.50% | | 0.50% | 0.50% | 0.50% | 0.50% | 0.25% | 0.50% |
| | CHI 725 | | | 0.50% | | | | | | |
| Inorganic fine | ELECOM V-8802 | | | | | 15.00% | | | | |
| particles (c) | ELECOM V-8803 | | | | | | 15.00% | 15.00% | 15.00% | |
| | MiBK-ST | | | | 15.00% | | | | | |
| Surfactant (d) | FP-1 | 0.05% | 0.05% | 0.05% | 0.05% | 0.05% | 0.05% | | | 0.05% |
| | Ftergent 710FM | | | | | | | 0.05% | 0.05% | |
| Other | Smectite | | | | | | | | | 1.00% |
| compounds | Cross-linking acryl- | | | | | | | | | 8.00% |
| | styrene particles | | | | | | | | | |
| Solvent | MEK | 50% | 50% | 50% | 50% | 50% | 50% | 50% | 50% | 50% |
| | MiBK | 30% | 30% | 30% | 30% | 30% | 30% | 30% | 30% | 30% |
| | Methyl acetate | 20% | 20% | 20% | 20% | 20% | 20% | 20% | 20% | 20% |

| | | | | | | | | | |
|---|---|---|---|---|---|---|---|---|---|
| Notes | Example | Example | Example | Example | Example | Example | Example | Example | Example |

TABLE 2

| | | Sample No. | | | | | | | | | | | | | | | | | | | | | | | | | |
|---|---|---|---|---|---|---|---|---|---|---|---|---|---|---|---|---|---|---|---|---|---|---|---|---|---|---|---|
| | | P01 | | P02 | | P03 | | P04 | | P05 | | P06 | | P07 | | P08 | | P09 | | P10 | | P11 | | P12 | | P13 | |
| | | Hard coat layer coating liquid No. | | | | | | | | | | | | | | | | | | | | | | | | | |
| | | a01 | | a02 | | a02 | | a03 | | a04 | | a05 | | a05 | | a05 | | a06 | | a07 | | a08 | | a09 | | a10 | |
| Layer | Transparent | 25 | μm | 25 | μm | 25 | μm | 25 | μm | 25 | μm | 25 | μm | 25 | μm | 25 | μm | 25 | μm | 25 | μm | 25 | μm | 25 | μm | 25 | μm |
| configuration | support | TAC | | TAC | | TAC | | TAC | | TAC | | TAC | | TAC | | TAC | | TAC | | TAC | | TAC | | TAC | | TAC | |
| | Hard coat | 10.0 | μm | 10.0 | μm | 15.0 | μm | 10.0 | μm | 10.0 | μm | 10.0 | μm | 15.0 | μm | 3.0 | μm | 10.0 | μm | 7.0 | μm | 7.0 | μm | 7.0 | μm | 7.0 | μm |
| | layer film | | | | | | | | | | | | | | | | | | | | | | | | | | |
| | thickness | | | | | | | | | | | | | | | | | | | | | | | | | | |
| Evaluation | Curling | 4.8 | mm | 3.4 | mm | 7.5 | mm | 0.0 | mm | −6.8 | mm | 3.4 | mm | 7.5 | mm | 0.0 | mm | −7.2 | mm | 4.8 | mm | 3.5 | mm | 3.1 | mm | 4.0 | mm |
| result | [mm] | | | | | | | | | | | | | | | | | | | | | | | | | | |
| | Curling | B | | B | | C | | A | | C | | B | | C | | A | | C | | B | | B | | B | | B | |
| | evaluation | | | | | | | | | | | | | | | | | | | | | | | | | | |
| | Film | A | | A | | A | | A | | A | | A | | A | | A | | A | | A | | A | | A | | A | |
| | change | | | | | | | | | | | | | | | | | | | | | | | | | | |
| | after | | | | | | | | | | | | | | | | | | | | | | | | | | |
| | 1,000 h at | | | | | | | | | | | | | | | | | | | | | | | | | | |
| | 60° C., RH | | | | | | | | | | | | | | | | | | | | | | | | | | |
| | 90%, | | | | | | | | | | | | | | | | | | | | | | | | | | |
| | Flatness | B | | B | | B | | B | | B | | B | | B | | A | | A | | B | | A | | A | | B | |
| | Interference | A | | A | | A | | A | | A | | A | | A | | B | | A | | B | | B | | B | | B | |
| | fringe | | | | | | | | | | | | | | | | | | | | | | | | | | |
| | Liquid | C01 | | C02 | | C03 | | C04 | | C05 | | C06 | | C07 | | C08 | | C09 | | C10 | | C11 | | C12 | | C13 | |
| | crystal cell | | | | | | | | | | | | | | | | | | | | | | | | | | |
| | No. | | | | | | | | | | | | | | | | | | | | | | | | | | |
| | Light | B | | B | | A | | A | | A | | A | | A | | B | | A | | A | | A | | A | | A | |
| | leakage | | | | | | | | | | | | | | | | | | | | | | | | | | |
| | evaluation | | | | | | | | | | | | | | | | | | | | | | | | | | |
| Notes | Example | Example | | Example | | Example | | Example | | Example | | Example | | Example | | Example | | Example | | Example | | Example | | Example | | Example | |
| | | Sample No. | | | | | | | | | | | | | | | | | | | | | | | | | |
| | | P14 | | P15 | | P16 | | P17 | | P18 | | P19 | | P20 | | P21 | | P22 | | S01 | | S02 | | P23 | | P24 | |
| | | Hard coat layer coating liquid No. | | | | | | | | | | | | | | | | | | | | | | | | | |
| | | a11 | | a12 | | a13 | | a14 | | a15 | | a16 | | a16 | | a16 | | a16 | | a16 | | a16 | | a17 | | a18 | |
| Layer | Transparent | 25 | μm | 25 | μm | 25 | μm | 25 | μm | 25 | μm | 25 | μm | 20 | μm | 30 | μm | 40 | μm | 30 | μm | 40 | μm | 40 | μm | 25 | μm |
| configuration | support | TAC | | TAC | | TAC | | TAC | | TAC | | TAC | | TAC | | TAC | | TAC | | Acryl | | Acryl | | TAC | | TAC | |
| | Hard coat | 7.0 | μm | 7.0 | μm | 7.0 | μm | 7.0 | μm | 7.0 | μm | 7.0 | μm | 8.5 | μm | 7.0 | μm | 7.0 | μm | 4.0 | μm | 4.0 | μm | 7.0 | μm | 6.0 | μm |
| | layer film | | | | | | | | | | | | | | | | | | | | | | | | | | |
| | thickness | | | | | | | | | | | | | | | | | | | | | | | | | | |
| Evaluation | Curling | 3.2 | mm | 4.8 | mm | 3.4 | mm | 3.0 | mm | 0.5 | mm | 0.0 | mm | 2.7 | mm | 0.0 | mm | 0.0 | mm | 6.9 | mm | 6.5 | mm | 7.5 | mm | 7.9 | mm |

| | | | | | | | | | | | | | | |
|---|---|---|---|---|---|---|---|---|---|---|---|---|---|---|
| result | [mm] | | | | | | | | | | | | | |
| | Curling | B | B | B | B | A | A | A | A | A | C | C | C | C |
| | evaluation | | | | | | | | | | | | | |
| | Film | A | A | A | A | A | A | A | A | A | A | A | A | A |
| | change | | | | | | | | | | | | | |
| | after | | | | | | | | | | | | | |
| | 1,000 h at | | | | | | | | | | | | | |
| | 60° C., RH | | | | | | | | | | | | | |
| | 90%, | | | | | | | | | | | | | |
| | Flatness | A | B | A | A | A | A | A | B | B | B | B | B | B |
| | Interference | B | B | B | B | B | A | A | A | B | A | B | B | A |
| | fringe | | | | | | | | | | | | | |
| | Liquid | C14 | C15 | C16 | C17 | C18 | C19 | C20 | C21 | C22 | C23 | C24 | C25 | C26 |
| | crystal cell | | | | | | | | | | | | | |
| | No. | | | | | | | | | | | | | |
| | Light | A | A | A | A | A | A | A | B | B | B | B | B | A |
| | leakage | | | | | | | | | | | | | |
| | evaluation | | | | | | | | | | | | | |
| Notes | Example | Example | Example | Example | Example | Example | Example | Example | Example | Example | Example | Example | Example | Example |

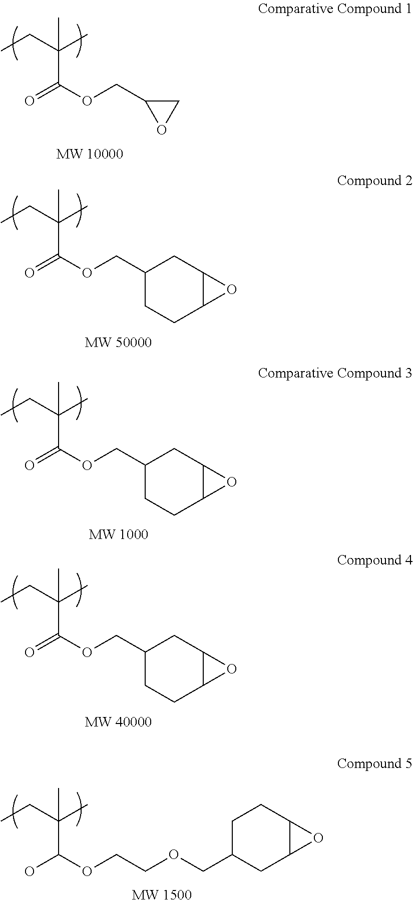

### Synthesis Example 1

### Synthesis of Compound 2

10.0 g of methylethylketone was charged to a 300 ml three-necked flask provided with a stirrer, a thermometer, a reflux cooling tube and a nitrogen gas introducing tube, and warmed up to 80° C. Then, a mixed solution containing Cyclomer M (19.63 g, 0.1 moles), methylethylketone (10.0 g) and “V-601” (manufactured by Wako Pure Chemical Industries, LTD., 0.23 g) was added dropwise thereto at a constant speed over 6 hours until the dropping was completed. After the dropping was completed, stirring was further performed for 12 hours, and the solvent was evaporated under reduced pressure. Then, through drying under reduced pressure at 80° C., Cyclomer M polymer (24.20 g) was obtained. The weight average molecular weight (Mw) of the polymer was calculated in terms of polystyrene by 50000 gel permeation chromatography (GPC), and the used column was TSKgel SuperHZM-H, TSKgel SuperHZ4000, or TSKgel SuperHZ200 (manufactured by TOSOH CORPORATION).

### Synthesis Example 2

### Synthesis of Comparative Compound 3

Comparative compound 3 in which a weight average molecular weight(Mw) of a polymer is 1000 was obtained in the same manner as in Synthesis Example 1 except that the amount of “V-601” (manufactured by Wako Pure Chemical Industries, LTD.) was changed to 23.26 g.

### Synthesis Example 3

### Synthesis of Comparative Compound 1

14.1 g of methylethylketone was charged to a 300 ml three-necked flask provided with a stirrer, a thermometer, a reflux cooling tube and a nitrogen gas introducing tube, and warmed up to 80° C. Then, a mixed solution containing methacrylic acid glycidyl (14.12 g, 0.1 moles), methylethylketone (14.1 g) and “V-601” (manufactured by Wako Pure Chemical Industries, LTD., 1.15 g) was added dropwise thereto at a constant speed over 6 hours until the dropping was completed. After the dropping was completed, stirring was further performed for 12 hours, and the solvent was evaporated under reduced pressure. Then, through drying under reduced pressure at 80° C., comparative compound 1 (13.20 g) was obtained. The weight average molecular weight (Mw) of the polymer was calculated in terms of polystyrene by 10000 gel permeation chromatography (GPC), and the used column was TSKgel SuperHZM-H, TSKgel SuperHZ4000, or TSKgel SuperHZ200 (manufactured by TOSOH CORPORATION).

### Synthesis Example 4

### Synthesis of Compound 4

10.0 g of methylethylketone was charged to a 300 ml three-necked flask provided with a stirrer, a thermometer, a reflux cooling tube and a nitrogen gas introducing tube, and warmed up to 80° C. Then, a mixed solution containing styrene (1 mole) adduct of 3-ethoxymethyl-7-oxabicyclo[4.1.0]heptane (26.04 g, 0.1 moles) synthesized by a conventional method, methylethylketone (10.0 g) and “V-601” (manufactured by Wako Pure Chemical Industries, LTD., 0.46 g) was added dropwise thereto at a constant speed over 6 hours until the dropping was completed. After the dropping was completed, stirring was further performed for 12 hours, and the solvent was evaporated under reduced pressure. Then, through drying under reduced pressure at 80° C., compound 4 (24.90 g) was obtained. The weight average molecular weight (Mw) of the polymer was calculated in terms of polystyrene by 32000 gel permeation chromatography (GPC), and the used column was TSKgel SuperHZM-H, TSKgel SuperHZ4000, or TSKgel SuperHZ200 (manufactured by TOSOH CORPORATION).

### Synthesis Example 5

### Synthesis of Compound 5

10.0 g of methylethylketone was charged to a 300 ml three-necked flask provided with a stirrer, a thermometer, a reflux cooling tube and a nitrogen gas introducing tube, and warmed up to 80° C. Then, a mixed solution containing N-(2-(7-oxabicyclo[4.1.0]heptane-3-ylmethoxy)ethyl)methacrylamide (23.93 g, 0.1 moles) synthesized by a conventional method, methylethylketone (10.0 g) and “V-601” (manufactured by Wako Pure Chemical Industries, LTD., 0.69 g) was added dropwise thereto at a constant speed over 6 hours until the dropping was completed. After the dropping was completed, stifling was further performed for 12 hours, and the solvent was evaporated under reduced pressure. Then, through drying under reduced pressure at 80° C., compound 5 (21.70 g) was obtained. The weight average molecular weight(Mw) of the polymer was calculated in terms of polystyrene by 29000 gel permeation chromatography (GPC), and the used column was TSKgel SuperHZM-H, TSKgel SuperHZ4000, or TSKgel SuperHZ200 (manufactured by TOSOH CORPORATION).
DPHA: KAYARD DPHA (manufactured by Nippon Kayaku Co., LTD.)
ATMMT: pentaerythritoltetraacrylate (manufactured by Shin-Nakamura Chemical Co., LTD.)
UV-1700B: urethaneacrylate (manufactured by The Nippon Synthetic Chemical Industry Co., LTD.)
Irgacure 127: alkylphenone-based photopolymerization initiator (manufactured by BASF)
Irgacure 290: sulfonium salt-based cationic polymerization initiator (manufactured by BASF)
Irgacure 270: sulfonium salt-based cationic polymerization initiator (manufactured by BASF)
UVR-6110: bifunctional alicyclic epoxy resin (molecular weight=252: manufactured by the Dow Chemical Company)
FK-1: photocationic polymerization initiator as shown in the following structure (iodonium salt compound)

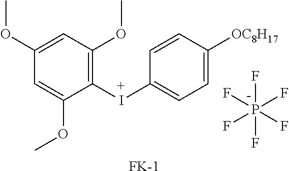

B2380: iodonium salt-based cationic polymerization initiator (manufactured by Tokyo Chemical Industry Co., LTD.)
CGI 725: non-ionic cationic polymerization initiator (manufactured by BASF)
ELECOM V-8802: MiBK dispersion liquid of spherical silica fine particles having a polymerizable group (solid content 40% by mass, average particle diameter 12 nm, manufactured by JGC CORPORATION)
ELECOM V-8803: MiBK dispersion liquid of silica fine particles in an irregular form (a connection form in a chain shape) having a polymerizable group (solid content 40% by mass, manufactured by JGC CORPORATION)
MEK-ST: MiBK dispersion liquid of silica fine particles to which a reactive group is not given (solid content 30% by mass, average particle diameter 10 nm to 20 nm, manufactured by NISSAN CHEMICAL INDUSTRIES, LTD.)
FP-1: fluorine-containing compound as described below

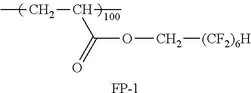

Ftergent 710FM (Neos Corporation)
MEK: methylethylketone
MiBK: methylisobutylketone

### (Coating of Hard Coat Layer)

Triacetyl cellulose (TAC) films with a thickness of 40 μm, 30 μm, 25 μm, and 20 μm wound in a roll form were unwound, and coating liquids a01 to a18, and b01 to b06 for a hard coat layer were used to manufacture polarizing plate protective films P01 to P24, and Q01 to Q08 while the film thickness of the hardened hard coat layer was adjusted to the thickness noted in Tables 3 and 4.

In S01, 02, on the acrylic substrate film prepared by the following method, a hard coat layer was formed using a liquid a16.

Specifically, in a die coating method using a slot die as described in Example 1 of Japanese Patent Application Laid-Open No. 2006-122889, each coating liquid was applied under a condition of a conveying speed of 30 m/min, and dried at 60° C. for 150 sec, and the coated layer was hardened by being irradiated with UV rays (intensity 400 mW/cm², dose 500 mJ/cm²) by an air-cooled metal halide lamp (manufactured by EYE GRAPHICS CO., LTD.) of 160 W/cm at about 0.1% by volume of an oxygen concentration under purged nitrogen to form a hard coat layer, followed by winding-up.

### (Manufacturing of 40 μm Acrylic Substrate Film)

To a reaction vessel having an inner volume of 30 L which is provided with a stirring device, a temperature sensor, a cooling tube and a nitrogen inlet tube, methyl methacrylate (MMA, 8000 g), methyl 2-(hydroxymethyl)acrylate (MHMA, 2000 g) and toluene (10000 g) as a polymerization solvent were charged, and heated up to 105° C. while nitrogen was allowed to flow through the mixture. At a point of time when the reflux was initiated according to a temperature rise, t-amyl peroxy isononanoate (10.0 g) as a polymerization initiator was added, and a solution consisting of t-amyl peroxy isononanoate (20.0 g) and toluene (100 g) was added dropwise over 2 hours, while solution polymerization was proceeded under reflux at about 105° C. to 110° C., followed by aging for 4 hours. The polymerization reaction rate was 96.6%, and the content (weight ratio) of MHMA in the obtained polymer was 20.0%.

Then, to the resultant polymer solution, 10 g of stearyl phosphate/distearyl phosphate mixture as a cyclization reaction catalyst (manufactured by Sakai Chemical Industry Co., LTD., Phoslex A-18) was added, and a cyclization condensation reaction was performed under reflux at about 80° C. to 100° C. for 5 hours.

Then, the resultant polymer solution was introduced into a vent-type twin-screw extruder (φ=29.75 mm, L/D=30) having one rear vent and four fore vents at a barrel temperature of 260° C., a rotational speed of 100 rpm, and a reduced pressure of 13.3 hPa to 400 hPa (10 mmHg to 300 mmHg), and at a processing rate of 2.0 kg/h in terms of a resin amount, and subjected to a cyclization condensation reaction and devolatilization in the extruder. Then, after the devolatilization was completed, the resin in a hot-melted state which was left in the extruder was discharged from the tip of the extruder, and pelletized with a pelletizer to obtain transparent pellets made of an acrylic resin having a lactone ring structure in the main chain. The weight-average molecular weight of the resin was 148,000, the melt flow rate was 11.0 g/10 min (which was obtained based on JIS K7120 at a test temperature of 240° C. and a load of 10 kg, and the same also applies to the following preparation examples), and the glass transition temperature was 130° C.

Then, the resultant pellets and AS resin (manufactured by TOYO STYRENE Co., LTD., product name: TOYO ASAS20) were kneaded using a single screw extruder (φ=30 mm) (a weight ratio of pellet/AS resin=90/10), thereby obtaining transparent pellets with a glass transition temperature of 127° C.

The prepared pellets of the resin composition were melt-extruded from a coat hanger type T-die using a twin-screw extruder to prepare a resin film with a thickness of about 160 μm.

Then, the obtained unstretched resin film was simultaneously biaxially stretched in the longitudinal direction (length direction) by 2.0 times, and in the lateral direction (width direction) by 2.0 times to prepare a polarizing plate protective film. In the acrylic substrate film obtained as described above, a thickness was 40 μm, a total light transmittance was 92%, a haze was 0.3%, and a glass transition temperature was 127° C.

### (Preparation of 30 μm Acrylic Substrate Film)

Transparent pellets having a glass transition temperature of 127° C., which were prepared in the same manner as in the 40 μm acrylic substrate film, were melt-extruded from a coat hanger type T-die using a twin-screw extruder to prepare a resin film with a thickness of about 120 μm.

Then, the obtained unstretched resin film was simultaneously biaxially stretched in the longitudinal direction (length direction) by 2.0 times, and in the lateral direction (width direction) by 2.0 times to prepare a polarizing plate protective film. In the acrylic substrate film obtained as described above, a thickness was 30 μm, a total light transmittance was 92%, a haze was 0.25%, and a glass transition temperature was 127° C.

The prepared polarizing plate protective films P01 to P24, S01 to S02, and Q01 to Q08 were evaluated by the following evaluation methods.

### (Film Thickness of Hard Coat Layer)

The film thickness of the hard coat layer was calculated by measuring a film thickness of the prepared polarizing plate protective film using a contact type film thickness meter, and subtracting a support thickness from the measured film thickness value, in which the support thickness was measured in the same manner as in the polarizing plate protective film.

### (Curling Evaluation)

The polarizing plate protective film was cut into a size of 60 mm (along to a coating direction)×60 mm (along to a perpendicular direction to the coating direction), and was kept under a condition of 25° C. and RH 60% for 3 hours. Then, a weight was placed on a film so that a film end face protrudes by 1.5 cm, and the rising height of the end face (=curl value (K)) was measured.

This evaluation was performed in a coating direction, and a perpendicular direction to the coating direction, and the K values were calculated by averaging both a value in the coating direction and that of the perpendicular direction to the coating direction.

Meanwhile, in the table, plus curl values indicate that the coated surface (a surface having a hard coat layer) is curled inward with respect to the support, and minus curl values indicate that the coated surface is curled outward with respect to the support.

Also, the evaluation of curling was determined by the following criteria.

A: absolute value is less than 3.0 mm

B: absolute value is 3.0 mm or more and less than 6.0 mm

C: absolute value is 6.0 mm or more and less than 8.0 mm

D: absolute value is 8.0 mm or more

### [Flatness]

In the film, on the surface at the hard coat layer formation side, flatness was evaluated. Specifically, a reflected image of a fluorescent lamp on the hard coat layer formation surface was observed and evaluated as follows.

A: No distortion is present in the reflected image of the fluorescent lamp

B: a slight distortion is present in the reflected image of the fluorescent lamp, thereby resulting in no practical problem

C: a highly significant distortion is present in the reflected image of the fluorescent lamp, thereby resulting in a practical problem

### [Interference Fringe]

For preventing a rear surface reflection, a black tape was attached to an all surface opposite to the hard coat layer of the polarizing plate protective film, and the polarizing plate protective film was visually observed from the surface of the hard coat layer, and evaluated by the following evaluation criteria.

A: no interference fringe occurs.

B: an interference fringe slightly occurs, but is acceptable for a product.

C: an interference fringe occurs.

(Humidity/Heat Resistance Evaluation: Film Change after 1000 Hours at 60° C. RH 90%)

The polarizing plate protective film was left in an environment of 60° C., and RH 90% for 1000 hours, and kept at 25° C. and RH 60% for 2 hours. Then, the appearance was evaluated.

A: no appearance change

B: appearance change such as film white turbidity occurs

### [Surface Saponification Treatment of Film]

Each of the polarizing plate protective films P01 to P24, and Q01 to Q08 and the transparent support used for the polarizing plate protective film were immersed in an aqueous sodium hydroxide solution of 2.3 mol/L for 3 min at 55° C., washed in a washing bath at a room temperature, and neutralized with sulfuric acid of 0.05 mol/L at 30° C. The resultant product was washed again in a washing bath at a room temperature, and dried by a hot air of 100° C. In this manner, the film was subjected to the surface saponification treatment.

### (Preparation of Polarizing Plates P01 to P24 and Q01 to Q08)

A surface of each of the saponified polarizing plate protective films P01 to P24 and Q01 to Q08 which is not laminated with a hard coat layer, a stretched 25μ iodine PVA polarizer having a thickness of 25 μm, and a saponified transparent support were bonded in this manner by a PVA-based adhesive, and heat-dried to obtain polarizing plates P01 to P24 and Q01 to Q08.

Here, the longitudinal direction of a roll of the prepared polarizer and the longitudinal direction of the polarizing plate protective films P01 to P24, and Q01 to Q08 were disposed to be parallel to each other. Also, the longitudinal direction of a roll of the polarizer and the longitudinal direction of the roll of the transparent support were disposed to be parallel to each other.

### (Preparation of Polarizing Plates S01 to S02)

One side of a surface of each of the polarizing plate protective films S01 and S02 (which is not laminated with a hard coat layer) and a transparent support used for the polarizing plate protective film was subjected to corona treatment and, after that, an active energy ray-curable acrylic adhesive was coated using a micro gravure coater (gravure roll: #180; the rotational speed: 140%/line speed) to a thickness of 5 μm.

Then, both surfaces of the above stretched iodine PVA polarizer having a thickness of 25 μm were sandwiched with the above polarizing plate protective film and the above transparent support so that the adhesive-coated side comes contact with the polarizer and the above transparent protective film having the adhesive was bonded by a roll press. From the bonded transparent protective film side and the transparent support side (both sides), an electron beam was irradiated to obtain a polarizing plate. The line speed was 20 m/min, the acceleration voltage was 250 kV, and the radiation dose was 20 kGy.

Here, the longitudinal direction of a roll of the prepared polarizer and the longitudinal direction of the polarizing plate protective films S01 and S02 were disposed to be parallel to each other. Also, the longitudinal direction of a roll of the polarizer and the longitudinal direction of the roll of the transparent support were disposed to be parallel to each other.

### [Manufacturing of Liquid Crystal Display Device]

A surface side polarizing plate of a commercially available IPS type liquid crystal TV (manufactured by LG electronics, 42LS5600) was peeled off, and polarizing plates P01 to P24, S01 to S02 and Q01 to Q08 were adhered to the front side through an adhesive so that the absorption axis of the polarizing plate of the front side is arranged in a longitudinal direction (horizontal direction), and the hard coat layer becomes an outermost surface. The thickness of glass used for a liquid crystal cell was 0.5 mm.

In this manner, liquid crystal display devices C01 to C26, and D01 to D08 were obtained.

### [Light Leakage Evaluation]

The liquid crystal display devices C01 to C26 and D01 to D08 manufactured as described above were humidified for 24 hours at 50° C. and RH 90%, and left for 2 hours at 25° C. and RH 60%. Then, the backlight of the liquid crystal display device was lit and the light leakage at each of four corners of the panel was evaluated after 10 hours from the lighting.

The light leakage evaluation was performed by a three-stage evaluation based on a difference between an average brightness of the whole screen and a brightness at a portion having a larger light leakage in the four corners after shooting a black display screen from a screen front surface by using a luminance measuring camera “ProMetric” (manufactured by Radiant Imaging).

—Evaluation Index—

A: any light leakage is not visually recognized at panel four corners.

B: a slight light leakage is visually recognized at one or two corners among panel four corners, but is acceptable.

C: a strong light leakage occurs at panel four corners and is not acceptable.

TABLE 3

| | | Hard coat layer coating liquid | | | | | |
|---|---|---|---|---|---|---|---|
| | | b01 | b02 | b03 | b04 | b05 | b06 |
| Compound (a) | Comparative compound 1 | | | 10.00% | | | |
| | Compound 2 | 2.00% | 45.00% | | | | 15.00% |
| | Comparative compound 3 | | | | 10.00% | | |
| | UVR-6110 | | | | | 10.00% | |
| | Compound 4 | | | | | | |
| | Compound 5 | | | | | | |
| Compound (b) | DPHA | 94.45% | 51.75% | 86.45% | 86.45% | 96.45% | 35.50% |
| | ATMMT | | | | | | |
| | UV1700B | | | | | | |
| Radical | IRGACURE127 | 3.00% | 1.20% | 3.00% | 3.00% | 3.00% | 3.00% |
| polymerization | | | | | | | |
| initiator | | | | | | | |
| Cationic | IRGACURE290 | | | | | | |
| polymerization | IRGACURE270 | | | | | | |
| Initiator | FK-1 | | | | | | |
| | B2380 | 0.50% | 2.00% | 0.50% | 0.50% | 0.50% | 0.50% |
| | CGI725 | | | | | | |
| Inorganic fine | ELECOM V-8802 | | | | | | |
| particles (c) | ELECOM V-8803 | | | | | | |
| | MiBK-ST | | | | | | |
| Surfactant (d) | FP-1 | 0.05% | 0.05% | 0.05% | 0.05% | 0.05% | 0.05% |
| | Ftergent 710FM | | | | | | |
| Other compounds | Ethylene glycol | | | | | | |
| | dimethacrylate | | | | | | 45.95% |
| | Smectite | | | | | | |
| | Cross-linking acryl- | | | | | | |
| | styrene particles | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |
| Notes | | comparative | comparative | comparative | comparative | comparative | comparative |
| | | example | example | example | example | example | example |

TABLE 4

| | | Sample No. | | | | | | | |
|---|---|---|---|---|---|---|---|---|---|
| | | Q01 | Q02 | Q03 | Q04 | Q05 | Q06 | Q07 | Q08 |
| | | Hard coat layer coating liquid No. | | | | | | | |
| | | b01 | b02 | b03 | b04 | b05 | a02 | a02 | b06 |
| Layer | Support | 25 μm | 25 μm | 25 μm | 25 μm | 25 μm | 25 μm | 25 μm | 25 μm |
| configuration | | TAC | TAC | TAC | TAC | TAC | TAC | TAC | TAC |
| | Hard coat | 10.0 μm | 10.0 μm | 10.0 μm | 10.0 μm | 10.0 μm | 2.0 μm | 18.0 μm | 7.0 μm |
| | layer film | | | | | | | | |
| | thickness | | | | | | | | |
| Evaluation | Curling [mm] | 10.0 mm | −8.5 mm | 9.0 mm | 6.0 μm | 6.5 μm | 0.0 mm | 9.5 mm | 2.7 mm |
| result | Curling | D | D | D | C | C | A | D | A |
| | evaluation | | | | | | | | |
| | Film change | A | A | A | B | B | A | A | A |
| | after 1000 hr | | | | | | | | |
| | at 60° C. RH | | | | | | | | |
| | 90% | | | | | | | | |
| | Flatness | C | B | A | C | C | A | B | C |
| | Interference | C | A | C | C | C | C | B | C |
| | fringe | | | | | | | | |
| | liquid crystal | D01 | D02 | D03 | D04 | D05 | D06 | D07 | D08 |
| | cell No. | | | | | | | | |
| | light leakage | C | A | C | C | C | C | A | C |
| | evaluation | | | | | | | | |

| | | | | | | | | |
|---|---|---|---|---|---|---|---|---|
| Notes | comparative | comparative | comparative | comparative | comparative | comparative | comparative | comparative |
| | example | example | example | example | example | example | example | example |

It can be seen that in the polarizing plate protective film of Examples, a curling is small, a flatness is excellent, an interference fringe is suppressed, and a humidity/heat resistance is good as compared to in Comparative Examples. Also, it can be seen that a liquid crystal display device having a polarizing plate employing the polarizing plate protective film of Examples is excellent in a display quality due to a small light leakage in the humidity/heat test.

A low refractive index layer was coated on the polarizing plate protective films of the present invention a01 to a18 by the method described below. As a result, while the above described performance such as an excellent curling was maintained, a reduction of unwanted reflections was confirmed, thereby achieving a more excellent denseness of black.

### [Coating of Low Refractive Index Layer]

### (Preparation of Inorganic Particle Dispersion Liquid (B-1))

Silica fine particles having pores therein were manufactured by changing the conditions for preparation in Preparation Example 4 of Japanese Patent Application Laid-Open No. 2002-79616. On these in an aqueous dispersion liquid state, solvent substitution with methanol was performed. Finally, the solid content concentration was adjusted to be 20% by mass, and particles having an average particle diameter of 45 nm, the shell thickness of about 7 nm, the silica particle refractive index of 1.30 were obtained. This refers to a dispersion liquid (B).

The dispersion liquid (B) (500 parts by mass) was added and mixed with acryloyloxypropyl trimethoxysilane (15 parts by mass), and diisopropoxyaluminum ethylacetate (1.5 parts by mass), and ion exchange water (9 parts by mass) was added thereto. The mixture was reacted at 60° C. for 8 hours and cooled to a room temperature, and added with acetyl acetone (1.8 parts by mass). The solvent was substituted through distillation under reduced pressure while MEK was added so that the total liquid amount became substantially constant. Then, finally, the solid content concentration was adjusted to be 20% by mass to prepare a dispersion liquid (B-1).

### (Preparation of Coating Liquid for Low Refractive Index Layer)

A fluorine-containing polymer (P-12: a fluorine-containing copolymer, a compound exemplified in Japanese Patent Application Laid-Open No. 2007-293325) (7.6 g) was mixed with DPHA (1.4 g), a dispersion liquid (B-1) (2.4 g), a photopolymerization initiator (Irgacure 907, 0.46 g), methylethylketone (190 g), and a propylene glycolmonomethylether acetate (48 g), and the mixture was stirred, and filtered through a polypropylene-made filter having a pore diameter of 5 μm to prepare a coating liquid for a low refractive index layer.

### (Coating of Low Refractive Index Layer)

The polarizing plate protective film was unwound again, and the coating liquid for the low refractive index layer was coated through a die coating method using the slot die at a condition of a conveying speed of 30 m/min, dried at 90° C. for 75 sec, and irradiated with UV rays (intensity 400 mW/cm², dose 240 mJ/cm²) by an air-cooled metal halide lamp (manufactured by EYE GRAPHICS CO., LTD.) of 240 W/cm at an oxygen concentration of 0.01 to 0.1% under purged nitrogen to form a low refractive index layer with a thickness of 100 nm, followed by winding-up. Therefore, a polarizing plate protective film having the low refractive index layer was manufactured. The refractive index of the low refractive index layer was 1.46.

In manufacturing the polarizing plate employing the polarizing plate protective film in Examples, when only the thickness of the iodine PVA polarizer for the polarizer to be used was changed to 15 μm, it was found that the obtained liquid crystal display device had a smaller light leakage in the humidity/heat test and a more excellent display quality.

1. A polarizing plate protective film comprising:
a transparent support having a thickness of 40 μm or less, and
a hard coat layer having a film thickness of from 3 μm to 15 μm,
wherein the hard coat layer is a layer formed by curing a hard coat layer forming composition containing at least the following compounds (a) and (b), and
the hard coat layer forming composition contains the compound (a) in an amount of 5% to 40% by mass and the compound (b) in an amount of 40% by mass to 95% by mass, based on 100% by mass of the total solid content of the hard coat layer forming composition:
(a) a compound having a repeating unit represented by the following Formula (1) and having a weight average molecular weight of 1500 or more,
(b) a compound having three or more ethylenically unsaturated double bonding groups in a molecule: 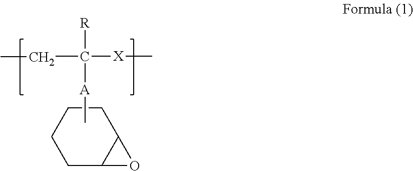
in Formula (1),
R represents a hydrogen atom or a methyl group,
X represents a single bond, or an oxygen atom, an alkylene group which may have a substituent, an arylene group which may have a substituent, an aralkylene group which may have a substituent, an ester bond, a carbonyl bond, —NH— or a linking group formed by combining them,
A represents a single bond, or an alkylene group which may have a substituent, an arylene group which may have a substituent, an aralkylene group which may have a substituent, an ester bond, an ether bond, a carbonyl bond, —NH— or a linking group formed by combining them.

2. The polarizing plate protective film according to claim 1,
wherein the hard coat layer forming composition contains (c) inorganic fine particles reactive with an epoxy group or an ethylenically unsaturated double bonding group in an amount of 5% to 40% by mass based on 100% by mass of the total solid content of the hard coat layer forming composition.

3. The polarizing plate protective film according to claim 1,
wherein the hard coat layer forming composition contains (d) a nonionic fluorine-containing surfactant represented by the following Formula (2): 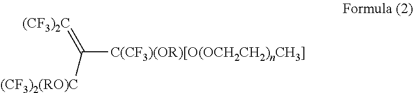
in Formula (2),
R represents an alkyl group having 1 to 6 carbon atoms, and
n represents a number of 3 to 50.

4. The polarizing plate protective film according to claim 1,
wherein a thickness of the transparent support is 30 μm or less.

5. The polarizing plate protective film according to claim 1,
wherein the transparent support is a cellulose acylate film, and a thickness of the transparent support is 25 μm or less.

6. The polarizing plate protective film according to claim 1,
wherein a thickness of the hard coat layer is from 3 μm to 10 μm.

7. The polarizing plate protective film according to claim 1, containing the compound (a) in an amount of 5% by mass to 22% by mass.

8. A polarizing plate comprising:
a polarizer, and
at least one polarizing plate protective film according to claim 1, as a protective film for the polarizer.

9. A liquid crystal display device comprising:
a liquid crystal cell, and
the polarizing plate according to claim 8, which is disposed at least one side surface of the liquid crystal cell,
wherein the polarizing plate protective film is disposed at an outermost surface.

10. A method of manufacturing a polarizing plate protective film which contains a transparent support with a thickness of 40 μm or less and a hard coat layer with a film thickness ranging from 3 μm to 15 μm, comprising:
forming a hard coat layer by curing a hard coat layer forming composition containing at least the following compounds (a) and (b),
wherein the hard coat layer forming composition contains the compound (a) in an amount of 5% to 40% by mass and the compound (b) in an amount of 40% by mass to 95% by mass based on 100% by mass of the total solid content of the hard coat layer forming composition:
(a) a compound having a repeating unit represented by Formula (1) below and having a weight average molecular weight of 1500 or more,
(b) a compound having three or more ethylenically unsaturated double bonding groups in a molecule: 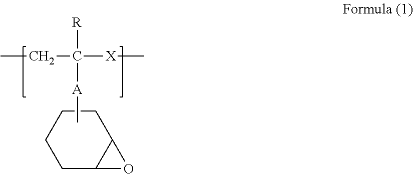
in Formula (1),
R represents a hydrogen atom or a methyl group,
X represents a single bond, or an oxygen atom, an alkylene group which may have a substituent, an arylene group which may have a substituent, an aralkylene group which may have a substituent, an ester bond, a carbonyl bond, —NH— or a linking group formed by combining them,
A represents a single bond, or an alkylene group which may have a substituent, an arylene group which may have a substituent, an aralkylene group which may have a substituent, an ester bond, an ether bond, a carbonyl bond, —NH— or a linking group formed by combining them.
